(19) United States
(12) Patent Application Publication
(10) Pub. No.: US 2015/0232244 A1
(43) Pub. Date: Aug. 20, 2015

(54) COVER MATERIAL FOR HERMETIC SEALING AND PACKAGE FOR CONTAINING ELECTRONIC COMPONENT

(71) Applicants: NEOMAX MATERIALS Co., Ltd., Suita-shi, Osaka (JP); HITACHI METALS, LTD., Minato-ku, Tokyo (JP)

(72) Inventors: Masayuki Yokota, Suita-shi (JP); Masaharu Yamamoto, Suita-shi (JP)

(73) Assignees: NEOMAX MATERIALS Co., Ltd., Suita-shi, Osaka (JP); HITACHI METALS, LTD., Minato-ku, Tokyo (JP)

(21) Appl. No.: 14/428,054

(22) PCT Filed: Nov. 8, 2013
(86) PCT No.: PCT/JP2013/080321

§ 371 Date: Mar. 13, 2015

(30) Foreign Application Priority Data
Nov. 12, 2012 (JP) 2012-248261

(51) Int. Cl. B65D 65/02; B32B 15/01; B65D 85/00; B65D 25/10; B65D 65/38

(52) U.S. Cl. CPC B65D 65/02; B65D 25/10; B65D 65/38; B65D 85/70; B32B 15/01

(57) ABSTRACT

This cover material for hermetic sealing is a cover material for hermetic sealing employed for a package for containing an electronic component. The cover material 1 for hermetic sealing is constituted of a clad material including a base material layer made of an Ni—Cr—Fe alloy containing Ni, Cr and Fe or an Ni—Cr—Co—Fe alloy containing Ni, Cr, Co and Fe, and a surface layer bonded to one surface of the base material layer on a side of an electronic component containing member and made of Ni or an Ni alloy.

### TECHNICAL FIELD

The present invention relates to a cover material for hermetic sealing and a package for containing an electronic component employing the same.

### BACKGROUND ART

A package for containing an electronic component employing a cover material for hermetic sealing is known in general. Such a package for containing an electronic component is disclosed in Japanese Patent Laying-Open No. 2012-74807, for example.

In Japanese Patent Laying-Open No. 2012-74807, a piezoelectric vibrator including a piezoelectric vibrating element, a package body (electronic component containing member) consisting of an insulating substrate having a recess portion in which the piezoelectric vibrating element is contained and a sealing ring made of Kovar arranged on a peripheral edge of an upper portion of the insulating substrate and a cover member (cover material for hermetic sealing) seam-welded to the sealing ring is disclosed. The cover member of this piezoelectric vibrator is made of an Ni-plated Kovar material (29Ni-16Co—Fe alloy).

When manufacturing the cover member, it is general to manufacture the same by press-working and bringing the Kovar material into prescribed dimensions and thereafter performing Ni plating on the surface of the Kovar material, in order to form an Ni plating layer on the whole surface of the Kovar material. As methods of forming Ni plating on the surface of the Kovar material, there are electroless Ni plating and electrolytic Ni plating.

### PRIOR ART

### Patent Document

Patent Document: Japanese Patent Laying-Open No. 2012-74807

### SUMMARY OF THE INVENTION

### Problems to be Solved by the Invention

In a case of performing electroless Ni plating on the surface of the Kovar material, however, a plurality of cover members plated in a barrel so overlap with each other that the thickness of Ni plating is easily dispersed. Thus, there is inconveniently a case where sufficient hermetic sealing cannot be performed due to dispersion in the thickness of the Ni plating at a time of welding the cover members and sealing rings to each other. When performing the electroless Ni plating on the surface of the Kovar material, therefore, it is necessary to introduce a dummy member for preventing overlapping of the plurality of cover members into the barrel, in order to prevent the thickness of the Ni plating from dispersion. Therefore, the number of cover members platable in the barrel at once decreases. Consequently, the time required for the electroless Ni plating per cover member lengthens.

Also in a case of performing the electrolytic Ni plating on the surface of the Kovar material, the thickness of Ni plating is easily dispersed as the plating speed is increased by increasing the current density at the time of the plating. Thus, there is inconveniently a case where sufficient hermetic sealing cannot be performed due to dispersion in the thickness of the Ni plating at a time of welding cover members and sealing rings to each other, similarly to the electroless Ni plating. When performing the electrolytic Ni plating on the surface of the Kovar material, therefore, it is necessary to reduce the plating speed by reducing the current density at the time of the plating, in order to prevent the thickness of the Ni plating from dispersion. Therefore, the time required for the electrolytic Ni plating per cover member lengthens.

Whichever one of the electroless Ni plating and the electrolytic Ni plating is performed, it is necessary to prevent corrosion of the cover members with a plating solution by sufficiently washing the cover members after the Ni plating. Therefore, the time required for the Ni plating per cover member further lengthens.

As a result of these, there is such a problem that the time required for the Ni plating per cover member so lengthens that the time (tact time) necessary for manufacturing one cover member lengthens in the piezoelectric vibrator disclosed in Japanese Patent Laying-Open No. 2012-74807.

In a case where the thickness of the Ni plating is dispersed, there is a case where the surface of the Kovar material is exposed. In this case, the Kovar material is corroded from a portion not covered with the Ni plating, and hence there is also such a problem that the corrosion resistance of the cover members lowers.

The present invention has been proposed in order to solve the aforementioned problems, and an object of the present invention is to provide a cover material for hermetic sealing capable of preventing corrosion resistance from lowering while preventing a time (tact time) necessary for manufacturing one cover material for hermetic sealing from lengthening and a package for containing an electronic component employing the same.

### Means for Solving the Problems

A cover material for hermetic sealing according to a first aspect of the present invention is a cover material for hermetic sealing employed for a package for containing an electronic component including an electronic component containing member for containing an electronic component, and constituted of a clad material including a base material layer made of an Ni—Cr—Fe alloy containing Ni, Cr and Fe or an Ni—Cr—Co—Fe alloy containing Ni, Cr, Co and Fe and a surface layer at least bonded to one surface of the base material layer on a side of the electronic component containing member and made of Ni or an Ni alloy.

The cover material for hermetic sealing according to the first aspect of the present invention is constituted of the clad material including the base material layer made of an Ni—Cr—Fe alloy or an Ni—Cr—Co—Fe alloy and the surface layer at least bonded to one surface of the base material layer on the side of the electronic component containing member and made of Ni or an Ni alloy as hereinabove described, whereby it is not necessary to perform Ni plating on the surface of the base material layer. Thus, a time (tact time) necessary for manufacturing one cover material for hermetic sealing can be prevented from lengthening as compared with a case of performing Ni plating.

In the cover material for hermetic sealing according to the first aspect, the base material layer is so made of an Ni—Cr—Fe alloy or an Ni—Cr—Co—Fe alloy that a passive state film mainly consisting of Cr₂O₃ is formed on the surface of the base material layer, whereby the corrosion resistance of the base material layer can be more improved than in a case where the base material layer is made of Kovar (29Ni-16Co—Fe alloy). Thus, the base material layer can be prevented from corroding from a portion not covered with the surface layer made of Ni or an Ni alloy, whereby the corrosion resistance of the cover material for hermetic sealing can be prevented from lowering.

Preferably in the aforementioned cover material for hermetic sealing according to the first aspect, the base material layer is made of an Ni—Cr—Fe alloy or an Ni—Cr—Co—Fe alloy containing at least 1 mass % and not more than 10 mass % of Cr. When structuring the cover material for hermetic sealing in this manner, a passive state film mainly consisting of Cr₂O₃ is reliably formed on the surface of the base material layer by setting the content of Cr in the base material layer to at least 1 mass %, whereby the corrosion resistance of the base material layer can be more improved. Further, the thermal expansion coefficient of the base material layer can be prevented from enlarging by setting the content of Cr in the base material layer to not more than 10 mass %, whereby thermal expansion difference between the electronic component containing member made of ceramics, for example, and the cover material for hermetic sealing can be prevented from enlarging. Thus, thermal stress generated between the cover material for hermetic sealing and the electronic component containing member can be reduced, whereby the package for containing an electronic component can be prevented from breaking due to thermal stress.

Preferably in this case, the base material layer is made of an Ni—Cr—Fe alloy or an Ni—Cr—Co—Fe alloy containing at least 6 mass % and not more than 10 mass % of Cr. When structuring the cover material for hermetic sealing in this manner, a passive state film mainly consisting of Cr₂O₃ is more reliably formed on the surface of the base material layer, whereby the corrosion resistance of the base material layer can be more improved.

Preferably in the aforementioned cover material for hermetic sealing according to the first aspect, the base material layer is made of an Ni—Cr—Co—Fe alloy containing at least 6 mass % and not more than 18 mass % of Co. When structuring the cover material for hermetic sealing in this manner, the thermal expansion coefficient of the base material layer can be prevented from enlarging by setting the content of Co in the base material layer to at least 6 mass % and not more than 18 mass %, whereby thermal expansion difference between the electronic component containing member made of ceramics, for example, and the cover material for hermetic sealing can be prevented from enlarging. Thus, thermal stress generated between the cover material for hermetic sealing and the electronic component containing member can be reduced, whereby the package for containing an electronic component can be prevented from breaking due to thermal stress.

Preferably in the aforementioned cover material for hermetic sealing according to the first aspect, the surface layer is made of an Ni—Cu alloy containing Ni and Cu. When structuring the cover material for hermetic sealing in this manner, the melting point of the surface layer can be lowered as compared with a case where the surface layer is made of Ni or a case where the same is made of another Ni alloy, whereby the temperature at the time of bonding between the cover material for hermetic sealing and the electronic component containing member can be lowered. Thus, thermal stress generated between the cover material for hermetic sealing and the electronic component containing member can be reduced.

Preferably in this case, the surface layer is made of an Ni—Cu alloy containing at least 30 mass % of Ni. When structuring the cover material for hermetic sealing in this manner, Ni excellent in corrosion resistance is sufficiently contained in the surface layer, whereby the corrosion resistance of the surface layer can be sufficiently ensured.

Preferably in the aforementioned structure in which the surface layer contains at least 30 mass % of Ni, the surface layer is made of an Ni—Cu alloy containing at least 60 mass % of Ni. When structuring the cover material for hermetic sealing in this manner, Ni is further sufficiently contained in the surface layer, whereby not only the corrosion resistance but also oxidation resistance can be effectively improved in the surface layer. Thus, the surface layer can be reliably prevented from oxidation also in a case where heat treatment is performed in the atmosphere.

Preferably in the aforementioned cover material for hermetic sealing according to the first aspect, the surface layer has a thickness of at least 1 μm and not more than 10 μm. When structuring the cover material for hermetic sealing in this manner, a thickness of the surface layer necessary for bonding can be sufficiently ensured in a case of employing the surface layer as a bonding layer to be welded with respect to the electronic component containing member, whereby hermetic sealing of the package for containing an electronic component can be prevented from becoming difficult. In the case of employing the surface layer as a bonding layer to be welded with respect to the electronic component containing member, further, the ratio of the surface layer not contributing to the bonding can be prevented from enlarging, by setting the thickness of the surface layer to not more than 10 μm.

Preferably in this case, the surface layer has a thickness of at least 2 μm and not more than 6 μm. When structuring the cover material for hermetic sealing in this manner, hermetic sealing of the package for containing an electronic component can be more prevented from becoming difficult, and the ratio of the surface layer not contributing to the bonding can be sufficiently reduced.

Preferably in the aforementioned cover material for hermetic sealing according to the first aspect, the surface layer includes a first surface layer bonded onto the surface of the base material layer on the side of the electronic component containing member and a second surface layer bonded onto another surface of the base material layer on a side opposite to the electronic component containing member. When structuring the cover material for hermetic sealing in this manner, the first surface layer and the second surface layer made of an Ni—Cu alloy containing Ni and Cu or Ni are arranged on the front and rear sides of the cover material for hermetic sealing respectively, whereby either one of both surfaces of the cover material for hermetic sealing can be bonded to the electronic component containing member. Thus, workability in the bonding between the cover material for hermetic sealing and the cover material for hermetic sealing can be improved.

Preferably in this case, the second surface layer is made of the same metallic material as the first surface layer. When structuring the cover material for hermetic sealing in this manner, the first surface layer and the second surface layer made of the same metallic material are arranged on the front and rear sides of the cover material for hermetic sealing respectively, whereby the front and rear sides of the cover material for hermetic sealing may not be distinguished from each other. Thus, workability in the bonding between the cover material for hermetic sealing and the electronic component containing member can be more improved.

Preferably in the aforementioned structure in which the surface layer includes the first surface layer and the second surface layer, the clad material includes a silver solder layer at least bonded onto a surface of the first surface layer on the side of the electronic component containing member. When structuring the cover material for hermetic sealing in this manner, the cover material for hermetic sealing and the electronic component containing member can be sealed with the silver solder layer without employing a sealing ring formed with silver solder or the like, whereby the number of components can be reduced when preparing the package for containing an electronic component. Further, the package for containing an electronic component can be miniaturized due to the non-provision of the sealing ring.

Preferably in the aforementioned structure in which the second surface layer is made of the same metallic material as the first surface layer, the base material layer is made of an Ni—Cr—Fe alloy containing at least 36 mass % and not more than 48 mass % of Ni, at least 1 mass % and not more than 10 mass % of Cr and Fe, and the first surface layer and the second surface layer are both made of an Ni—Cu alloy containing at least 30 mass % of Ni or Ni. When structuring the cover material for hermetic sealing in this manner, a time (tact time) necessary for manufacturing one cover material for hermetic sealing can be reliably prevented from lengthening while reliably ensuring the corrosion resistance of the cover material for hermetic sealing by setting the content of Cr in the base material layer to at least 1 mass %.

Preferably in the aforementioned structure in which the base material layer is an Ni—Cr—Fe alloy, the base material layer is made of an Ni—Cr—Fe alloy containing at least 36 mass % and not more than 48 mass % of Ni, at least 6 mass % and not more than 10 mass % of Cr and Fe, and the first surface layer and the second surface layer are both made of an Ni—Cu alloy containing at least 30 mass % of Ni. When structuring the cover material for hermetic sealing in this manner, the tact time can be more reliably prevented from lengthening while more reliably ensuring the corrosion resistance of the cover material for hermetic sealing by setting the content of Cr in the base material layer to at least 6 mass %. Further, the surface layer is so made of an Ni—Cu alloy that the melting point of the surface layer can be lowered as compared with a case where the surface layer is made of Ni, whereby the temperature at the time of bonding between the cover material for hermetic sealing and the electronic component containing member can be lowered. Thus, thermal stress generated between the cover material for hermetic sealing and the electronic component containing member can be reduced.

Preferably in the aforementioned structure in which the base material layer contains at least 6 mass % and not more than 18 mass % of Co, the base material layer is made of an Ni—Cr—Co—Fe alloy containing at least 1 mass % and not more than 10 mass % of Cr, at least 6 mass % and not more than 18 mass % of Co and Fe. When structuring the cover material for hermetic sealing in this manner, the time (tact time) necessary for manufacturing one cover material for hermetic sealing can be reliably prevented from lengthening while reliably ensuring the corrosion resistance of the cover material for hermetic sealing by setting the content of Cr in the base material layer to at leas 1 mass %. Further, the thermal expansion coefficient of the base material layer can be prevented from enlarging by setting the content of Co in the base material layer to at least 6 mass % and not more than 18 mass %, whereby the thermal expansion difference between the electronic component containing member made of ceramics, for example, and the cover material for hermetic sealing can be prevented from enlarging. Thus, thermal stress generated between the cover material for hermetic sealing and the electronic component containing member can be reduced, whereby the package for containing an electronic component can be prevented from breaking due to thermal stress.

Preferably in the aforementioned cover material for hermetic sealing according to the first aspect, the surface layer bonded to the surface of the base material layer on the side of the electronic component containing member is configured to function as a melting bonding layer when resistance-welded with respect to the electronic component containing member. When structuring the cover material for hermetic sealing in this manner, the cover material for hermetic sealing including the surface layer functioning as a bonding layer and the electronic component containing member can be easily bonded to each other by resistance welding.

A package for containing an electronic component according to a second aspect of the present invention includes an electronic component containing member for containing an electronic component and the aforementioned cover material for hermetic sealing according to the first aspect resistance-welded with respect to the package for containing an electronic component.

The package for containing an electronic component according to the second aspect of the present invention can prevent the base material layer of the aforementioned cover material for hermetic sealing according to the first aspect from corroding from a portion not covered with the surface layer made of Ni or an Ni alloy, whereby the corrosion resistance of the cover material for hermetic sealing can be prevented from lowering.

Preferably in the aforementioned package for containing an electronic component according to the second aspect, the surface layer bonded to the surface of the base material layer on the side of the electronic component containing member functions as a melting bonding layer when resistance-welded with respect to the package for containing an electronic component. When structuring the package for containing an electronic component in this manner, the cover material for hermetic sealing including the surface layer functioning as a bonding layer and the electronic component containing member can be easily bonded to each other by resistance welding.

### Effect of the Invention

According to the present invention, as hereinabove described, the corrosion resistance of the cover material for hermetic sealing can be prevented from lowering while preventing the time (tact time) necessary for manufacturing one cover material for hermetic sealing from lengthening.

### BRIEF DESCRIPTION OF THE DRAWINGS

FIG. 1 A perspective view showing the structure of a cover material for hermetic sealing according to one embodiment of the present invention.

FIG. 2 A sectional view along the line 400-400 in FIG. 1.

FIG. 3 A perspective view showing the structure of a package for containing an electronic component according to one embodiment of the present invention.

FIG. 4 A sectional view along the line 500-500 in FIG. 3.

FIG. 5 A perspective view showing the structure of an electronic component containing member according to one embodiment of the present invention.

FIG. 6 A perspective view for illustrating a manufacturing process for the package for containing an electronic component according to one embodiment of the present invention.

FIG. 7 A table showing results of a corrosion resistance test of cover materials for hermetic sealing conducted in order to confirm effects of one embodiment of the present invention.

FIG. 8 A table showing results of a seam welding test (fixed condition test) conducted in order to confirm effects of one embodiment of the present invention.

FIG. 9 A table showing results of a seam welding test (varied condition test) conducted in order to confirm effects of one embodiment of the present invention.

FIG. 10 A table showing results of leak tests and reliability tests of Example 1 conducted in order to confirm effects of one embodiment of the present invention.

FIG. 11 A table showing results of leak tests and reliability tests of Examples 3 to 6 conducted in order to confirm effects of one embodiment of the present invention.

FIG. 12 A table showing results of a corrosion resistance test of Ni—Cu alloys conducted in order to confirm effects of one embodiment of the present invention.

FIG. 13 A table showing results of an oxidation resistance test of Ni—Cu alloys conducted in order to confirm effects of one embodiment of the present invention.

FIG. 14 A graph showing results of an oxidation resistance test of Ni—Cu alloys conducted in order to confirm effects of one embodiment of the present invention.

FIG. 15 A graph of thermal expansion coefficients for studying the composition of a base material layer according to one embodiment of the present invention.

FIG. 16 A table of thermal expansion coefficients for studying the composition of the base material layer according to one embodiment of the present invention.

FIG. 17 A sectional view showing the structure of a cover material for hermetic sealing according to a first modification of the embodiment of the present invention.

FIG. 18 A sectional view showing the structure of a cover material for hermetic sealing according to a second modification of the embodiment of the present invention.

FIG. 19 A sectional view showing the structure of a package for containing an electronic component according to the second modification of the embodiment of the present invention.

### MODES FOR CARRYING OUT THE INVENTION

An embodiment embodying the present invention is now described on the basis of the drawings.

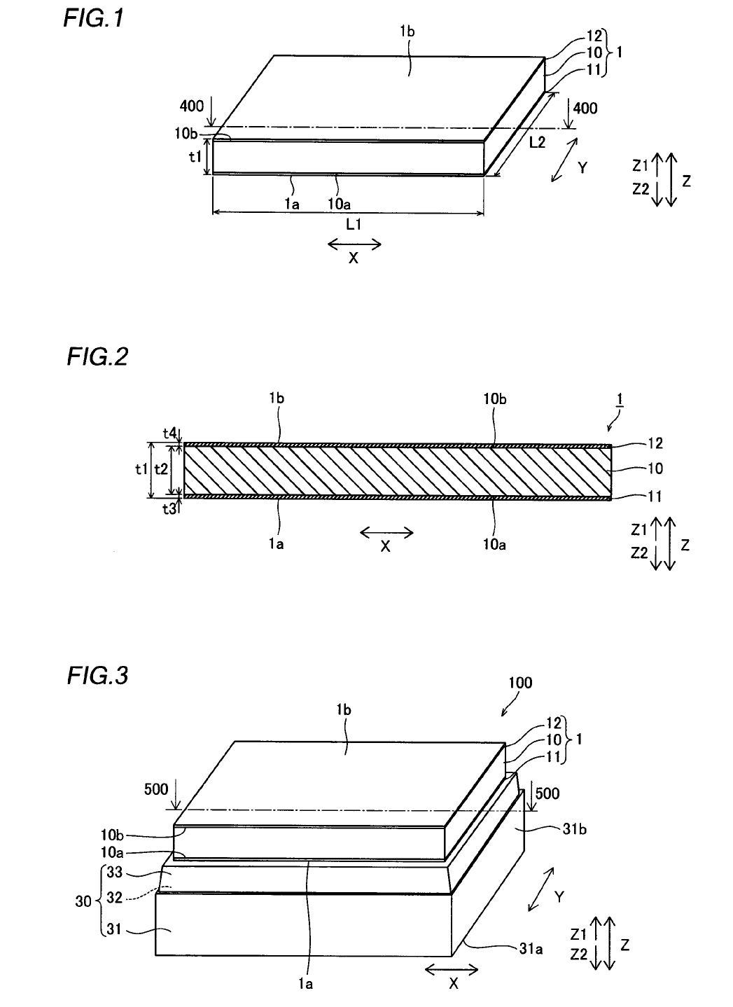

First, the structure of a cover material 1 for hermetic sealing according to one embodiment of the present invention is described with reference to FIGS. 1 and 2.

The cover material 1 for hermetic sealing according to one embodiment of the present invention is employed for a package 100 for containing an electronic component including an electronic component containing member 30 for containing a crystal unit 20 described later. The cover material 1 for hermetic sealing has a length L1 of about 2.3 mm in the longitudinal direction (X direction), a length L2 of about 1.8 mm in the short-side direction (Y direction) and a thickness t1 of about 80 μm in the thickness direction (Z direction), as shown in FIG. 1.

The cover material 1 for hermetic sealing consists of a three-layer clad material constituted of a base material layer 10 and surface layers 11 and 12 pressure-bonded to a lower surface 10a (the surface on a Z2 side) and an upper surface 10b (the surface on a Z1 side) of the base material layer 10 respectively, as shown in FIG. 2. The surface layers 11 and 12 are arranged on the side of a lower surface 1a and the side of an upper surface 1b of the cover material 1 for hermetic sealing respectively. The surface layer 11 arranged on the side of the lower surface 1a of this cover material 1 for hermetic sealing functions as a melting bonding layer when welded with respect to the electronic component containing member 30 by seam welding which is a sort of resistance welding. The surface layers 11 and 12 are examples of the “first surface layer” and the “second surface layer” in the present invention respectively, while the lower surface 10a and the upper surface 10b are examples of “one surface” and “another surface” in the present invention respectively.

According to this embodiment, the base material layer 10 is made of an Ni—Cr—Fe alloy consisting of Ni, Cr, Fe and unavoidable impurities or an Ni—Cr—Co—Fe alloy consisting of Ni, Cr, Co, Fe and unavoidable impurities. The content of Ni in the Ni—Cr—Fe alloy or the Ni—Cr—Co—Fe alloy constituting the base material layer 10 is preferably approximately at least 36 mass % and not more than 48 mass %, and more preferably in the vicinity of 42 mass %. The content of Cr in the Ni—Cr—Fe alloy or the Ni—Cr—Co—Fe alloy is preferably approximately at least 1 mass % and not more than 10 mass %, and more preferably approximately at least 4 mass % and not more than 10 mass %. Further preferably, the content of Cr is approximately at least 6 mass % and not more than 10 mass %. In the case where the base material layer 10 is made of the Ni—Cr—Co—Fe alloy, the content of Co is preferably approximately at least 6 mass % and not more than 18 mass %. The base material layer 10 is further preferably made of an Ni—Cr—Co—Fe alloy approximately containing at least 36 mass % and not more than 48 mass % of Ni, at least 6 mass % and not more than 10 mass % of Cr, at least 6 mass % and not more than 18 mass % of Co and Fe.

The surface layers 11 and 12 are made of the same metallic material, and made of an Ni—Cu alloy consisting of Ni, Cu and unavoidable impurities, or Ni. In view of lowering of the melting point, the surface layers 11 and 12 are preferably made of an Ni—Cu alloy approximately containing at least 30 mass % of Ni and not more than 70 mass % of Cu, or Ni, and more preferably made of an Ni—Cu alloy approximately containing at least 30 mass % of Ni and not more than 70 mass % of Cu. In view of attaining oxidation resistance, the surface layers 11 and 12 are preferably made of an Ni—Cu alloy approximately containing at least 45 mass % of Ni and not more than 55 mass % of Cu, or Ni, and more preferably made of an Ni—Cu alloy approximately containing at least 60 mass % of Ni and not more than 40 mass % of Cu, or Ni.

The cover material 1 for hermetic sealing preferably consists of the three-layer clad material constituted of the base material layer 10 made of an Ni—Cr—Fe alloy or an Ni—Cr—Co—Fe alloy approximately containing at least 36 mass % and not more than 48 mass % of Ni, at least 1 mass % and not more than 10 mass % of Cr and Fe and the surface layers 11 and 12 made of an Ni—Cu alloy approximately containing at least 30 mass % of Ni, or Ni. Further, the cover material 1 for hermetic sealing more preferably consists of the three-layer clad material constituted of the base material layer 10 made of an Ni—Cr—Fe alloy or an Ni—Cr—Co—Fe alloy approximately containing at least 36 mass % and not more than 48 mass % of Ni, at least 4 mass % and not more than 10 mass % of Cr and Fe and the surface layers 11 and 12 made of an Ni—Cu alloy approximately containing at least 30 mass % of Ni, or Ni. The cover material 1 for hermetic sealing further preferably consists of the three-layer clad material constituted of the base material layer 10 made of an Ni—Cr—Fe alloy approximately containing at least 36 mass % and not more than 48 mass % of Ni, at least 6 mass % and not more than 10 mass % of Cr and Fe and the surface layers 11 and 12 made of an Ni—Cu alloy approximately containing at least 30 mass % of Ni.

Cr in the Ni—Cr—Fe alloy constituting the base material layer 10 is so oxidized that passive state films mainly consisting of Cr₂O₃ are formed at least on portions of side surfaces of the cover material 1 for hermetic sealing on which the base material layer 10 is exposed. Thus, the cover material 1 for hermetic sealing is so configured that the corrosion resistance of the base material layer 10 improves.

The base material layer 10 has a thickness t2 of approximately 74 μm, the surface layer 11 has a thickness t3 of approximately 3 μm, and the surface layer 12 has a thickness t4 of approximately 3 μm. The thickness t3 of the surface layer 11 is preferably a thickness of approximately at least 1 μm and not more than 10 μm, and more preferably a thickness of approximately at least 2 μm and not more than 6 μm. Further, the thickness t3 is preferably a thickness of approximately at least 3 μm and not more than 4 μm. In order to bring the front and rear sides of the cover material 1 for hermetic sealing into the same structure, the thickness t3 of the surface layer 11 and the thickness t4 of the surface layer 12 are preferably the same thickness.

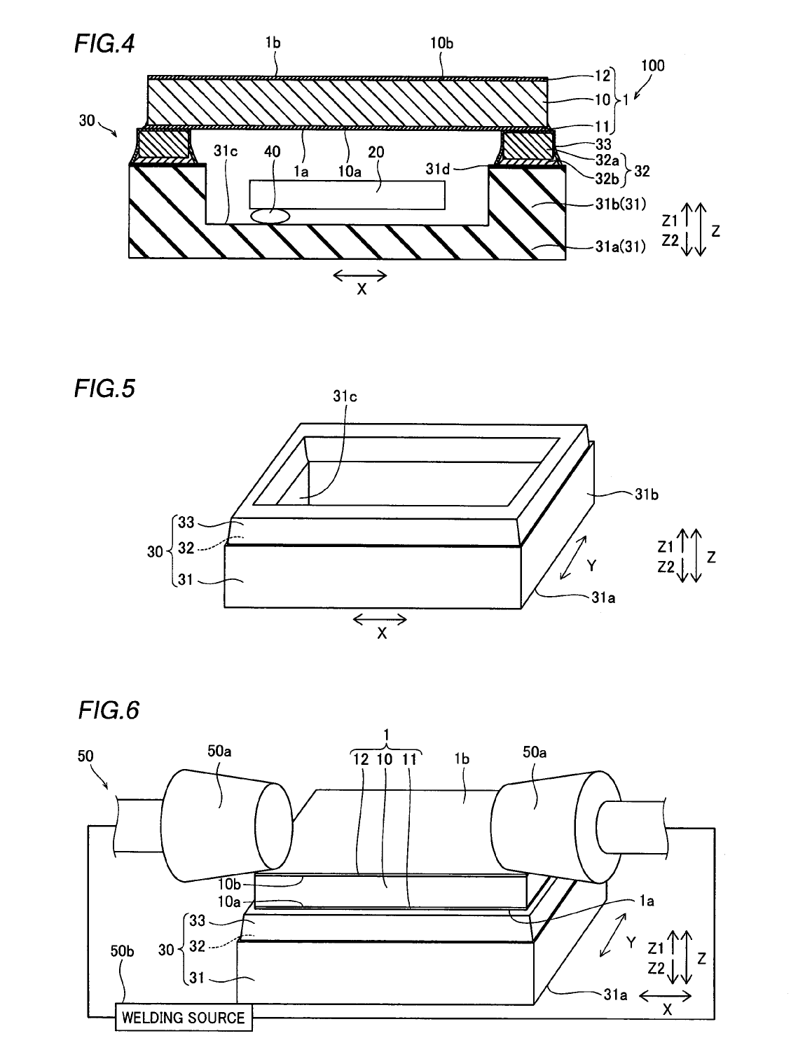

The structure of the package 100 for containing an electronic component for which the cover material 1 for hermetic sealing according to one embodiment of the present invention is employed is now described with reference to FIGS. 3 and 4.

The package 100 for containing an electronic component according to this embodiment includes the cover material 1 for hermetic sealing and the electronic component containing member 30 hermetically sealed by the cover material 1 for hermetic sealing in a state containing the crystal unit 20 (see FIG. 4), as shown in FIGS. 3 and 4. In the package 100 for containing an electronic component, the cover material 1 for hermetic sealing is so arranged on the electronic component containing member 30 that the surface layer 11 of the cover material 1 for hermetic sealing is on the side (the lower side, the Z2 side) of the electronic component containing member 30. The crystal unit 20 is an example of the “electronic component” in the present invention.

The electronic component containing member 30 includes a box-shaped base 31 made of alumina (Al₂O₃) which is ceramics, a ring-shaped sealing ring 32 brazed/bonded to the base 31 and a protective plating layer 33 covering the sealing ring 32.

The base 31 includes a bottom portion 31a on the Z2 side and a side portion 31b formed to extend upward (toward the Z1 side) from the outer peripheral edge of the upper surface (the surface on the Z1 side) of the bottom portion 31a, as shown in FIG. 4. A recess portion 31c is formed on the electronic component containing member 30, to be surrounded by the bottom portion 31a and the side portion 31b. The crystal unit 20 is contained in the recess portion 31c in a state fixed to the recess portion 31c with a bump 40.

A metallized layer 31d is formed on an upper end of the side portion 31b. This metallized layer 31d is so formed as to render brazing/bonding between the ceramics (Al₂O₃) constituting the base 31 and metal (Kovar) constituting the sealing ring 32 excellent. The metallized layer 31d has such a structure that a W layer, an Ni layer and an Au layer (not shown) are stacked in this order from the upper end of the side portion 31b upward (toward the side of the sealing ring 32, the Z1 side).

The sealing ring 32 made of metal has a base material 32a made of Kovar (29Ni-16Co—Fe alloy) and a silver solder portion 32b arranged on at least the lower surface of the base material 32a. Heat is applied in a state where the metallized layer 31d of the base 31 and the silver solder portion 32b of the sealing ring 32 are in contact with each other, whereby the silver solder portion 32b is molten. Thus, the base 31 and the sealing ring 32 are brazed/bonded to each other. Further, the protective plating layer 33 consisting of an Ni plating layer and an Au plating layer (not shown) is formed to cover the sealing ring 32 in the state where the base 31 and the sealing ring 32 are brazed/bonded to each other.

The cover material 1 for hermetic sealing is welded by seam welding which is a sort of resistance welding to be bonded with respect to the electronic component containing member 30 in a state arranged on the upper surface of the sealing ring 32 of the electronic component containing member 30. In other words, the surface layer 11 of the cover material 1 for hermetic sealing is so molten by the seam welding that the cover material 1 for hermetic sealing is bonded to the upper surface of the sealing ring 32.

A manufacturing process for the package 100 for containing an electronic component according to one embodiment of the present invention is now described with reference to FIGS. 1 to 6.

First, a base material (not shown) made of an Ni—Cr—Fe alloy and a pair of surface materials (not shown) made of an Ni—Cu alloy or Ni are prepared, and the surface materials are arranged on both surfaces of the base material respectively. The ratios between the thickness of the surface material, the thickness of the base material and the thickness of the surface material are about 4:92:4. Then, a clad material (not shown) in which the surface materials are bonded to both surfaces of the base material respectively is prepared by rolling/working the base material and the pair of surface materials by employing a rolling mill (not shown). At this time, the clad material is rolled until the thickness t1 (see FIG. 2) of the clad material becomes about 80 μm, whereby the thickness t2 (see FIG. 2) of the base material layer 10 becomes approximately 74 μm, while the thickness t3 (see FIG. 2) of the surface layer 11 and the thickness t4 (see FIG. 2) of the surface layer 12 both become approximately 3 μm.

Thereafter the clad material is punch-worked (press-worked) into a rectangular shape of the length L1 (see FIG. 1) of about 2.3 mm in the longitudinal direction (X direction) and the length L2 (see FIG. 1) of about 1.8 mm in the short-side direction (Y direction). Thus, the cover material 1 for hermetic sealing consisting of the three-layer clad material constituted of the base material layer 10 and the surface layers 11 and 12 pressure-bonded to the lower surface 10a (the surface on the Z2 side) and the upper surface 10b (the surface on the Z1 side) of the base material layer 10 respectively is manufactured, as shown in FIGS. 1 and 2. In this cover material 1 for hermetic sealing consisting of the three-layer clad material, there is no need to perform Ni plating.

Further, the base 31 and the sealing ring 32 are prepared, as shown in FIG. 5. Then, the base 31 and the sealing ring 32 are arranged in a vacuum furnace (not shown) in a state bringing the metallized layer 31d (see FIG. 4) of the base 31 and the silver solder portion 32b (see FIG. 4) of the sealing ring 32 into contact with each other. Then, the silver solder portion 32b is molten at a prescribed temperature, thereby brazing/bonding the base 31 and the sealing ring 32 to each other. Thereafter the electronic component containing member 30 is manufactured by forming the protective plating layer 33 to cover the sealing ring 32.

Then, the cover material 1 for hermetic sealing is arranged on the upper surface of the sealing ring 32 in a state containing the crystal unit 20 (see FIG. 4) in the electronic component containing member 30, as shown in FIG. 6. Then, the cover material 1 for hermetic sealing and the electronic component containing member 30 are bonded to each other by seam welding. More specifically, a pair of roller electrodes 50a of a seam welding machine 50 are arranged on a peripheral edge portion of the cover material 1 for hermetic sealing. Then, the pair of roller electrodes 50a are moved in the X direction or in the Y direction at a prescribed welding speed along the peripheral edge portion of the cover material 1 for hermetic sealing while feeding current from a welding source 50b at a prescribed output under a nitrogen atmosphere or under a vacuum atmosphere. Thus, heat is generated on bonded regions of the surface layer 11 arranged on the side of the lower surface 1a of the cover material 1 for hermetic sealing and the upper surface of the sealing ring 32 of the electronic component containing member 30. Consequently, the surface layer 11 functioning as a bonding layer is molten, and the cover material 1 for hermetic sealing is welded with respect to the electronic component containing member 30. Consequently, the package 100 for containing an electronic component shown in FIGS. 3 and 4 is manufactured.

According to this embodiment, as hereinabove described, the cover material 1 for hermetic sealing is configured to consist of the three-layer clad material constituted of the base material layer 10 made of an Ni—Cr—Fe alloy or an Ni—Cr—Co—Fe alloy and the surface layers 11 and 12 pressure-bonded to the lower surface 10a and the upper surface 10b of the base material layer 10 respectively and made of an Ni—Cu alloy or Ni. Thus, there is no need to perform Ni plating on the surface of the base material layer 10. Consequently, a time (tact time) necessary for manufacturing one cover material 1 for hermetic sealing can be prevented from lengthening and a necessary cost can be prevented from enlarging as compared with a case of performing Ni plating.

According to this embodiment, the base material layer 10 is so made of an Ni—Cr—Fe alloy or an Ni—Cr—Co—Fe alloy that passive state films mainly consisting of Cr₂O₃ are formed on the side surfaces where the base material layer 10 is exposed, whereby the corrosion resistance of the base material layer 10 can be more improved than in a case where the base material layer 10 is made of Kovar (29Ni-16Co—Fe alloy). Thus, the base material layer 10 can be prevented from corroding from side surfaces of the base material layer 10 not covered with the surface layers 11 and 12 made of an Ni—Cu alloy or Ni, whereby the corrosion resistance of the cover material 1 for hermetic sealing can be prevented from lowering.

According to this embodiment, the base material layer 10 is made of an Ni—Cr—Fe alloy or an Ni—Cr—Co—Fe alloy approximately containing at least 1 mass % and not more than 10 mass % of Cr. Preferably, the base material layer 10 is made of an Ni—Cr—Fe alloy or an Ni—Cr—Co—Fe alloy approximately containing at least 6 mass % and not more than 10 mass % of Cr. Thus, passive state films mainly consisting of Cr₂O₃ are reliably formed on the side surfaces where the base material layer 10 is exposed, whereby the corrosion resistance of the base material layer 10 can be more improved. Further, the thermal expansion coefficient of the base material layer 10 can be prevented from enlarging, whereby thermal expansion difference between the electronic component containing member 30 made of Al₂O₃ and the cover material 1 for hermetic sealing can be prevented from enlarging. Thus, thermal stress generated between the cover material 1 for hermetic sealing and the electronic component containing member 30 can be reduced, whereby the package 100 for containing an electronic component can be prevented from breaking due to thermal stress.

According to this embodiment, the base material layer 10 is made of an Ni—Cr—Co—Fe alloy containing approximately at least 36 mass % and not more than 48 mass % of Ni, approximately at least 6 mass % and not more than 10 mass % of Cr, at least 6 mass % and not more than 18 mass % of Co and Fe. Thus, the thermal expansion coefficient of the base material layer 10 can be prevented from enlarging, whereby thermal expansion difference between the base 31 of the electronic component containing member 30 made of alumina and the cover material 1 for hermetic sealing can be prevented from enlarging. Thus, thermal stress generated between the cover material 1 for hermetic sealing and the electronic component containing member 30 can be reduced, whereby the package 100 for containing an electronic component can be prevented from breaking due to thermal stress.

According to this embodiment, Ni excellent in corrosion resistance is further sufficiently contained in the surface layers 11 and 12 when the surface layers 11 and 12 are made of an Ni—Cu alloy containing at least 60 mass % of Ni, whereby not only the corrosion resistance but also the oxidation resistance can be effectively improved in the surface layers 11 and 12. Thus, the surface layers 11 and 12 can be reliably prevented from oxidation also in a case where heat treatment is performed in the atmosphere. Further, the melting point of the surface layer 11 can be lowered as compared with a case where the surface layer 11 is made of Ni or a case where the same is made of another Ni alloy, whereby the temperature at the time of the seam welding of the cover material 1 for hermetic sealing and the electronic component containing member 30 can be lowered. Thus, heat applied to the crystal unit 20 can be reduced, and thermal stress generated between the cover material 1 for hermetic sealing and the electronic component containing member 30 can be reduced.

According to this embodiment, the surface layers 11 and 12 have the thicknesses t3 and t4 of approximately 3 μm respectively so that the thickness t3 of the surface layer 11 necessary for bonding the surface layer 11 with respect to the electronic component containing member 30 can be sufficiently ensured, whereby hermetic sealing of the package 100 for containing an electronic component can be more prevented from becoming difficult. Further, the ratio of the surface layer 11 not contributing to the bonding can be sufficiently reduced.

According to this embodiment, the surface layers 11 and 12 arranged on the lower surface 1a and the upper surface 1b of the cover material 1 for hermetic sealing respectively are made of the same metallic material, whereby the front and rear sides of the cover material 1 for hermetic sealing may not be distinguished from each other. Thus, workability in the bonding between the cover material 1 for hermetic sealing and the cover material 30 for hermetic sealing can be more improved.

According to this embodiment, the cover material 1 for hermetic sealing preferably consists of a three-layer clad material constituted of the base material layer 10 made of an Ni—Cr—Fe alloy approximately containing at least 36 mass % and not more than 48 mass % of Ni, at least 1 mass % and not more than 10 mass % of Cr and Fe and the surface layers 11 and 12 made of an Ni—Cu alloy approximately containing at least 30 mass % of Ni, or Ni. More preferably, the cover material 1 for hermetic sealing consists of a three-layer clad material constituted of the base material layer 10 made of an Ni—Cr—Fe alloy approximately containing at least 36 mass % and not more than 48 mass % of Ni, at least 6 mass % and not more than 10 mass % of Cr and Fe and the surface layers 11 and 12 made of an Ni—Cu alloy approximately containing at least 30 mass % of Ni. When structuring the cover material 1 for hermetic sealing in this manner, the time (tact time) necessary for manufacturing one cover material 1 for hermetic sealing can be reliably prevented from lengthening while reliably ensuring the corrosion resistance of the cover material 1 for hermetic sealing by setting the content of Cr in the base material layer 10 to at least 1 mass %.

According to this embodiment, the surface layer 11 arranged on the side of the lower surface 1a of the cover material 1 for hermetic sealing is configured to function as the bonding layer molten when seam-welded with respect to the electronic component containing member 30, whereby the cover material 1 for hermetic sealing including the surface layer 11 functioning as the bonding layer and the electronic component containing member 30 can be easily bonded to each other by seam welding.

### EXAMPLES

A corrosion resistance test of cover materials for hermetic sealing conducted in order to confirm effects of the aforementioned embodiment, a seam welding test of the cover materials for hermetic sealing and electronic component containing members, leak tests and reliability tests of packages for containing electronic components, a corrosion resistance test and an oxidation resistance test of Ni—Cu alloys constituting surface materials of the cover materials for hermetic sealing and study of base material layers are now described with reference to FIGS. 2 and 5 to 15.

(Corrosion Resistance Test of Cover Material for Hermetic Sealing)

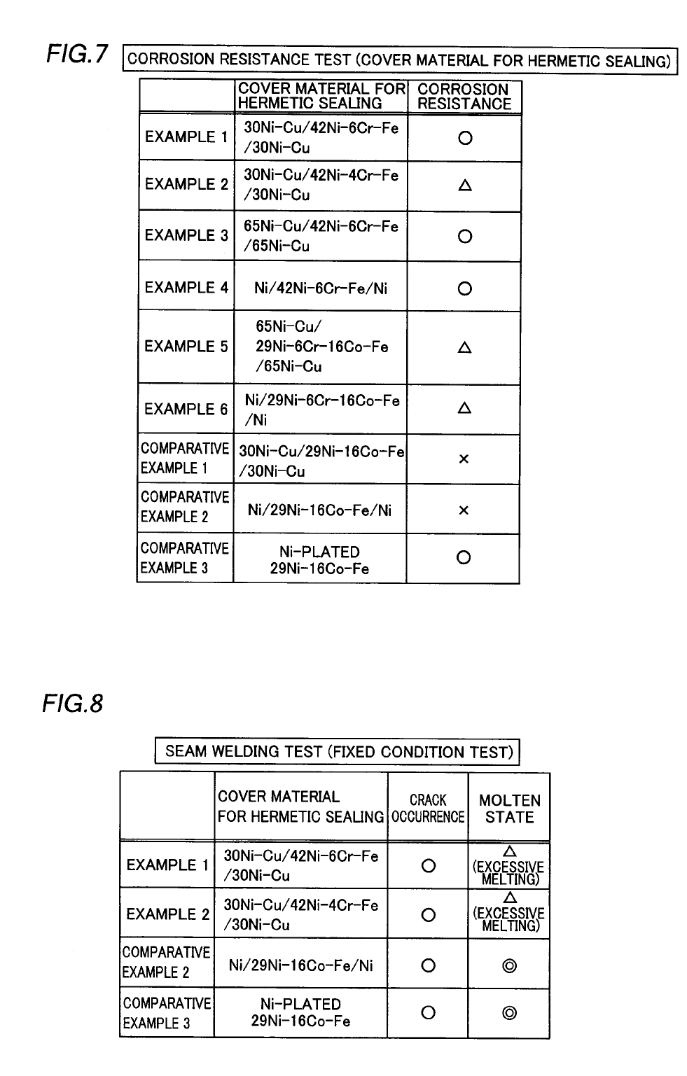

In the corrosion resistance test of the cover materials for hermetic sealing described below, cover materials 1 for hermetic sealing consisting of three-layer clad materials constituted of base material layers 10 made of 42Ni—Cr—Fe alloys and surface layers 11 and 12 made of Ni—Cu alloys or Ni were employed as Examples 1 to 4 corresponding to the cover material 1 for hermetic sealing (see FIG. 2) according to the aforementioned embodiment, as shown in FIG. 7. Further, cover materials 1 for hermetic sealing consisting of three-layer clad materials constituted of base material layers 10 made of 29Ni-6Cr-16Co—Fe alloys and surface layers 11 and 12 made of Ni—Cu alloys or Ni were employed as Examples 5 and 6 corresponding to the cover material 1 for hermetic sealing (see FIG. 2) according to the aforementioned embodiment.

In Example 1, a cover material 1 for hermetic sealing (30Ni—Cu/42Ni-6Cr—Fe/30Ni—Cu) consisting of a three-layer clad material constituted of a base material layer 10 made of a 42Ni-6Cr—Fe alloy containing 42 mass % of Ni, 6 mass % of Cr and Fe and surface layers 11 and 12 made of a 30Ni—Cu alloy containing 30 mass % of Ni and 70 mass % of Cu was employed.

In Example 2, a cover material 1 for hermetic sealing (30Ni—Cu/42Ni-4Cr—Fe/30Ni—Cu) including a base material layer 10 made of a 42Ni-4Cr—Fe alloy containing 42 mass % of Ni, 4 mass % of Cr and Fe was employed, dissimilarly to Example 1. In other words, the content of Cr was more reduced in the base material layer 10 according to Example 2 than in the base material layer 10 according to Example 1.

In Example 3, a cover material 1 for hermetic sealing (65Ni—Cu/42Ni-6Cr—Fe/65Ni—Cu) including surface layers 11 and 12 made of a 65Ni—Cu alloy containing 65 mass % of Ni and Cu was employed, dissimilarly to Example 1. In other words, the content of Ni was more enlarged in the surface layers 11 and 12 according to Example 2 than in the surface layers 11 and 12 according to Example 1.

In Example 4, a cover material 1 for hermetic sealing (Ni/42Ni-6Cr—Fe/Ni) including surface layers 11 and 12 made of Ni was employed, dissimilarly to Example 1. In other words, no Ni—Cu alloy containing Cu was employed in the surface layers 11 and 12 according to Example 4, dissimilarly to Examples 1 to 3.

In Example 5, a cover material 1 for hermetic sealing (65Ni—Cu/29Ni-6Cr-16Co—Fe/65Ni—Cu) including a base material layer 10 made of a 29Ni-6Cr-16Co—Fe alloy containing 29 mass % of Ni, 6 mass % of Cr, 16 mass % of Co and Fe and surface layers 11 and 12 made of a 65Ni—Cu alloy was employed, dissimilarly to Example 1.

In Example 6, a cover material 1 for hermetic sealing (Ni/29Ni-6Cr-16Co—Fe/Ni) including a base material layer 10 made of a 29Ni-6Cr-16Co—Fe alloy and surface layers 11 and 12 made of Ni was employed, dissimilarly to Example 1.

On the other hand, a cover material for hermetic sealing (30Ni—Cu/29Ni-16Co—Fe/30Ni—Cu) consisting of a three-layer clad material constituted of a base material layer made of an Fe-based alloy (29Ni-16Co—Fe alloy, the so-called Kovar) containing 29 mass % of Ni, 16 mass % of Co and Fe while containing no Cr and a pair of surface layers made of a 30Ni—Cu alloy was employed as comparative example 1 with respect to Examples 1 to 6.

Further, a cover material for hermetic sealing (Ni/29Ni-16Co—Fe/Ni) consisting of a three-layer clad material constituted of a base material layer made of a 29Ni-16Co—Fe alloy and a pair of surface layers made of Ni was employed as comparative example 2. In addition, a cover material for hermetic sealing (Ni-plated 29Ni-16Co—Fe) prepared by performing Ni plating on the whole surface of a base material layer made of a 29Ni-16Co—Fe alloy was employed as comparative example 3.

The cover materials for hermetic sealing according to Examples 1 to 6 and comparative examples 1 to 3 were formed to have lengths of 2.3 mm in the longitudinal direction (X direction), lengths of 1.8 mm in the short-side direction (Y direction) and thicknesses of 80 μm in the thickness direction (Z direction). The thicknesses of the base material layers of the cover materials for hermetic sealing according to Examples 1 to 6 and comparative examples 1 and 2 were 74 μm, and the thicknesses of the pairs of surface layers were equally 3 μm. The thickness of the base material layer of the cover material for hermetic sealing according to comparative example 3 was 74 μm, and the thickness of the Ni-plated layer was 3 μm.

A salt spray test was conducted with respect to the cover materials for hermetic sealing according to Examples 1 to 6 and comparative examples 1 to 3 in accordance with JIS C60068-2-11 under conditions of a temperature of 35±2° C., a salt concentration of 5±1 mass % and a pH of at least 6.5 and not more than 7.2 for 48 hours. Then, the extents of corrosion in the cover materials for hermetic sealing were observed.

Referring to FIG. 7, ◯ marks (circular marks) were put on cases where corrosion was hardly confirmable in the cover materials for hermetic sealing also after termination of the salt spray test (after a lapse of 48 hours). Further, Δ marks (triangular marks) were put on cases where slight corrosion was confirmed in the vicinity of peripheral edge portions of the cover materials for hermetic sealing after the termination of the salt spray test, notwithstanding that the corrosion was at degrees unproblematic in practice. In addition, x marks (x marks) were put on cases where remarkable corrosion was confirmed in the vicinity of peripheral edge portions of the cover materials for hermetic sealing after a lapse of 24 hours.

As shown in FIG. 7, the extents of corrosion in the cover materials 1 for hermetic sealing according to Examples 1 to 6 employing the Ni—Cr—Fe alloys or the Ni—Cr—Co—Fe alloys as the base material layers 10 were degrees unproblematic in practice, and it has been proved that the cover materials 1 for hermetic sealing have sufficient corrosion resistance. This is conceivably because passive state films mainly consisting of Cr₂O₃ were sufficiently formed on portions (side surfaces) where the base material layers 10 were exposed in the cover materials 1 for hermetic sealing according to Examples 1 to 6. Further, corrosion was hardly confirmable in the cover materials 1 for hermetic sealing according to Examples 1, 3 and 4 employing the 42Ni-6Cr—Fe alloys as the base material layers 10. Thus, it has been confirmable that corrosion resistance can be sufficiently improved up to a degree having corrosion resistance equivalent to that of the cover material for hermetic sealing according to comparative example 3 made of the Ni-plated 29Ni-16Co—Fe alloy, by employing the 42Ni-6Cr—Fe alloy as the base material layer 10. This is conceivably because the passive state films mainly consisting of Cr₂O₃ were sufficiently formed on the portions (side surfaces) where the base material layers 10 were exposed in the cover materials 1 for hermetic sealing according to Examples 1, 3 and 4.

In the cover materials for hermetic sealing according to comparative examples 1 and 2 employing the 29Ni-16Co—Fe alloys as the base material layers, on the other hand, remarkable corrosion was confirmed in the vicinity of the peripheral edge portions of the cover materials for hermetic sealing after a lapse of 24 hours. This is conceivably because the 29Ni-16Co—Fe alloys were corroded from side surfaces where the base material layers were exposed in the cover materials for hermetic sealing according to comparative examples 1 and 2. Thus, it has been confirmable that the corrosion resistance is insufficient in the case of employing the 29Ni-16Co—Fe alloy as the base material layer.

Thus, it has been proved as preferable to make the Ni—Cr—Fe alloy and the Ni—Cr—Co—Fe alloy contain at least 6 mass % of Cr, in order to improve the corrosion resistance of the Ni—Cr—Fe alloys. In the cover materials 1 for hermetic sealing according to Examples 2, 5 and 6, the extents of corrosion were obviously smaller than those in the cover materials for hermetic sealing according to comparative examples 1 and 2. In other words, it has been confirmable as possible to improve the corrosion resistance by employing the alloy containing Cr as the base material layer than in the case of employing the 29Ni-16Co—Fe alloy as the base material layer.

(Seam Welding Test)

In the seam welding test of the cover materials for hermetic sealing and the electronic component containing members described below, the same cover materials for hermetic sealing as the aforementioned Examples 1 and 2 and comparative examples 2 and 3 were employed.

The cover materials for hermetic sealing according to Examples 1 and 2 and comparative examples 2 and 3 and electronic component containing members 30 shown in FIG. 5 were seam-welded by employing a semiautomatic seam welding machine 50 (NAW-1105C, by Nippon Avionics Co., Ltd.), as shown in FIG. 6. More specifically, the pair of roller electrodes 50a were moved in the X direction or the Y direction at a prescribed welding speed along the peripheral edge portions of the cover materials for hermetic sealing while feeding current from the welding source 50b at a prescribed output under a nitrogen atmosphere. Thus, the cover materials for hermetic sealing and the electronic component containing members were welded to each other.

First, seam welding of the cover materials for hermetic sealing according to Examples 1 and 2 and comparative examples 2 and 3 and the electronic component containing members was performed in a state (basic conditions) setting the output of the semiautomatic seam welding machine 50 to a prescribed reference value and setting the welding speed to 10 mm/sec (fixed condition test). These basic conditions are ordinary conditions at a time of welding the cover material for hermetic sealing (Ni-plated 29Ni-16Co—Fe alloy) according to comparative example and the electronic component containing member to each other.

Then, the presence or absence of occurrence of cracks resulting from thermal stress caused by heat at the time of the seam welding and molten states in the surface layers on the sides of the electronic component containing members were observed. Referring to FIG. 8, ◯ marks (circular marks) were put on cases where occurrence of cracks was not confirmable as evaluation of the presence or absence of occurrence of cracks. Further, X marks (x marks) were put on cases where occurrence of cracks was confirmable.

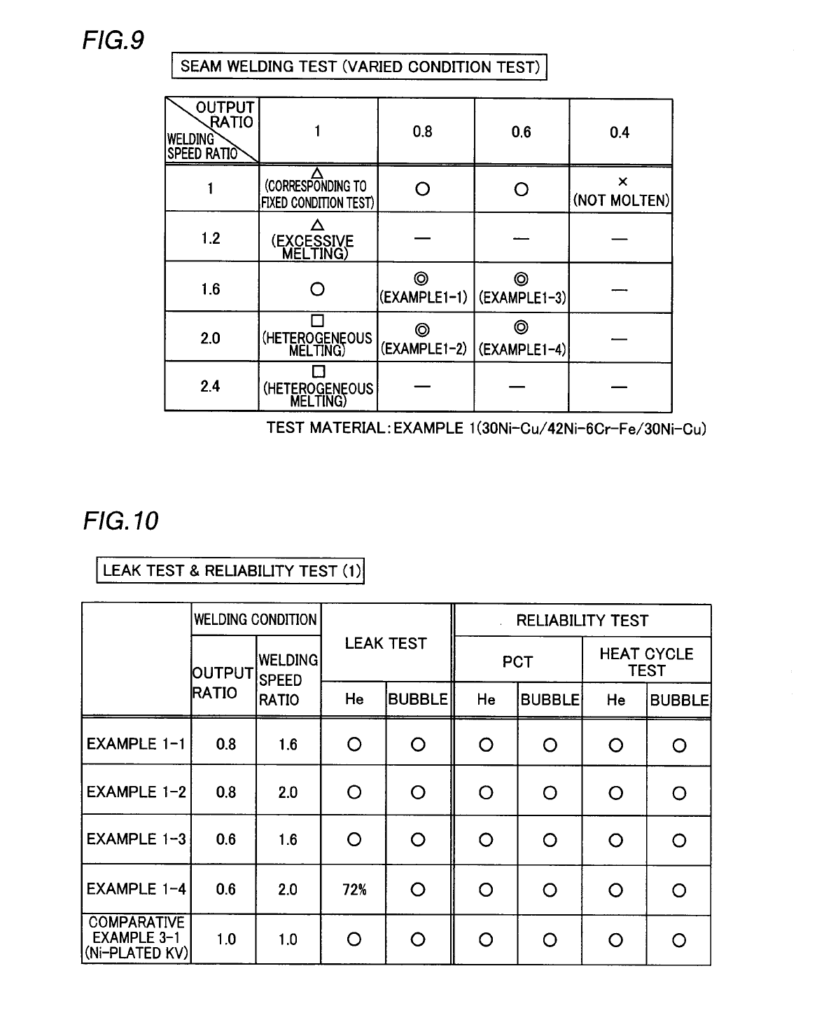

Referring to FIGS. 8 and 9, ⊚ marks (double circular marks) were put on cases where the surface layers were homogeneously molten neither too much nor too little in bonded regions of the surface layers of the cover materials for hermetic sealing and the electronic component containing members as evaluation of the molten states. Further, ◯ marks (circular marks) were put on cases where the surface layers were molten neither too much nor too little while the same were slightly heterogeneously molten in the bonded regions. In addition, Δ marks (triangular marks) were put on cases where the surface layers were excessively molten to cover the side surfaces of the cover materials for hermetic sealing (cases of excess melting). Further, □ marks (square marks) were put on cases where portions sufficiently molten and portions not sufficiently molten were heterogeneously present in the surface layers in the bonded regions (cases of heterogeneous melting). Further, a x mark (x mark) was put on a case where the surface layers were not sufficiently molten in the bonded regions.

As shown in FIG. 8, occurrence of cracks was not confirmable in any one of Examples 1 and 2 and comparative examples 2 and 3 as results of the fixed condition test. This is so conceivable that thermal stress resulting from heat at the time of the seam welding was sufficiently small since the difference between the thermal expansion coefficients of the electronic component containing member and the electronic component containing member was sufficiently small and no cracks occurred as a result in any one of Examples 1 and 2 and comparative examples 2 and 3. From this, it has been confirmable that occurrence of cracks can be prevented and the packages for containing electronic components can be prevented from breaking as a result also in the case of performing the seam welding by employing the cover materials 1 for hermetic sealing including the base material layers 10 made of the 42Ni—Cr—Fe alloys according to Examples 1 and 2, similarly to the case of performing the seam welding by employing the cover materials for hermetic sealing including the base material layers made of the 29Ni-16Co—Fe alloys according to comparative examples 2 and 3.

In Examples 1 and 2, melting of the surface layers became excessive, dissimilarly to comparative examples 2 and 3. With respect to this, the following reasons are conceivable. In other words, the specific resistance (about 34 μQ/cm) of the 30Ni—Cu alloys constituting the surface layers 11 of Examples 1 and 2 is larger than the specific resistance (about 8.5 μQ/cm) of Ni constituting the surface layers of comparative examples 2 and 3, and hence the quantities of heat generated in the bonded regions of the cover materials for hermetic sealing and the electronic component containing members are larger in Examples 1 and 2 than in comparative examples 2 and 3. Further, the melting point (about 1200° C.) of the 30Ni—Cu alloys is lower than the melting point (about 1450° C.) of Ni, and hence the surface layers are molten at lower temperatures in Examples 1 and 2 than in comparative examples 2 and 3. As results of these, the temperatures of the surface layers not only in the bonded regions but also in the vicinity thereof ascend beyond the melting point, due to the large quantities of heat generated in the bonded regions of the cover materials for hermetic sealing and the electronic component containing members. Consequently, the surface layers were conceivably excessively molten.

From this, it has been proved that seam welding with the electronic component containing members 30 is possible with smaller outputs and at higher welding speeds in the cover materials 1 for hermetic sealing according to Examples 1 and 2 including the surface layers 11 made of the 30Ni—Cu alloys.

Then, seam welding of the cover material 1 for hermetic sealing according to Example 1 and the electronic component containing member 30 was performed while varying the output and the welding speed (varied condition test). At this time, the output under the aforementioned basic conditions was set to 1 (prescribed reference value), and the output ratio in the semiautomatic seam welding machine 50 was varied to 1 (1 time as much as the prescribed reference value), 0.8 (0.8 times as much as the prescribed reference value), 0.6 (0.6 times as much as the prescribed reference value) and 0.4 (0.4 times as much as the prescribed reference value). Further, the welding speed under the aforementioned basic conditions was set to 1 (10 mm/sec), and the welding speed ratio in the semiautomatic seam welding machine 50 was varied to 1 (10 mm/sec), 1.2 (12 mm/sec), 1.6 (16 mm/sec), 2.0 (20 mm/sec) and 2.4 (24 mm/sec).

Then, molten states in the surface layer 11 of the cover material 1 for hermetic sealing on the side of the electronic component containing member 30 were observed. Evaluation of the molten states was performed similarly to the aforementioned fixed condition test.

In the case of varying the welding speed ratio in the state fixing the output ratio of the semiautomatic seam welding machine 500 to 1, melting of the surface layer 1 consisting of the 30Ni—Cu alloy became excessive in the cases where the welding speed ratio was 1 and 1.2 as results of the varied condition test, as shown in FIG. 9. This is conceivably because the output of the semiautomatic seam welding machine 50 was too large, and a time remaining in prescribed bonded regions was too long. In the cases where the welding speed ratio was 2.0 and 2.4, on the other hand, it became such a state that sufficiently molten portions and insufficiently molten portions were heterogeneously present in the surface layer 11 consisting of the 30Ni—Cu alloy. These are conceivably because the output of the semiautomatic seam welding machine 50 was too large, and the time remaining in the prescribed bonded regions was too short.

In the case where the output ratio of the semiautomatic seam welding machine 50 was 1 and the welding speed ratio was 1.6, on the other hand, the surface layer 11 was molten neither too much nor too little, although the same was slightly heterogeneously molten. This is conceivably because the time remaining in the prescribed bonded regions was appropriate.

Also in the cases where the welding speed ratio of the semiautomatic seam welding machine 50 was 1 and the output ratio was 0.8 and 0.6, the surface layer 11 was molten neither too much nor too little, although the same was slightly heterogeneously molten. This is conceivably because the output of the semiautomatic seam welding machine 50 was so low that the quantity of heat generated in the bonded regions of the cover material 1 for hermetic sealing and the electronic component containing member 30 was reduced. In the case where the welding speed ratio of the semiautomatic seam welding machine 50 was 1 and the output ratio was 0.4, on the other hand, the surface layer 11 was not sufficiently molten in the bonded regions. This is conceivably because the output of the semiautomatic seam welding machine 50 was too low.

In the case where the welding speed ratio of the semiautomatic seam welding machine 50 was 0.8 and the welding speed ratio was 1.6 or 2.0, and in the case where the welding speed ratio was 0.6 and the welding speed ratio was 1.6 or 2.0, the surface layer 11 was homogeneously molten neither too much nor too little in the bonded regions. Thus, it has been proved as possible to bring melting of the surface layer 11 into a homogeneous state neither too much nor too little when the output ratio of the semiautomatic seam welding machine 50 is at least 0.6 and not more than 0.8 and the welding speed ratio is at least 1.6 and not more than 2.0 in the case of employing the cover material 1 for hermetic sealing according to Example 1.

(Leak Test and Reliability Test of Package for Containing Electronic Component)

In the leak tests and the reliability tests of packages for containing electronic components described below, hermetic properties of the packages for containing electronic components were confirmed by employing a plurality of packages for containing electronic components prepared by employing the cover materials for hermetic sealing according to Examples 1, 3 to 6 and comparative example 3 in the aforementioned seam welding test (varied condition test).

At this time, a package 100 for containing an electronic component seam-welded under such conditions that the output ratio of the semiautomatic seam welding machine 50 was 0.8 and the welding speed ratio was 1.6 was employed as Example 1-1 in Example 1 (30Ni—Cu/42Ni-6Cr—Fe/30Ni—Cu). Further, a package 100 for containing an electronic component seam-welded under such conditions that the output ratio was 0.8 and the welding speed ratio was 2.0 was employed as Example 1-2. In addition, a package 100 for containing an electronic component seam-welded under such conditions that the output ratio was 0.6 and the welding speed ratio was 1.6 was employed as Example 1-3. Further, a package 100 for containing an electronic component seam-welded under such conditions that the output ratio was 0.6 and the welding speed ratio was 2.0 was employed as Example 1-4.

In Example 3 (65Ni—Cu/42Ni-6Cr—Fe/65Ni—Cu), Example 4 (Ni/42Ni-6Cr—Fe/Ni), Example 5 (65Ni—Cu/29Ni-6Cr-16Co—Fe/65Ni—Cu), Example 6 (Ni/29Ni-6Cr-16Co—Fe/Ni) and comparative example 3 (Ni-plated 29Ni-16Co—Fe), packages for containing electronic components seam-welded under such a condition that the output ratio of the semiautomatic seam welding machine 50 was 1.0 were employed as Examples 3 to 6 (comparative example 3)-1 respectively. Further, packages for containing electronic components seam-welded under such a condition that the output ratio of the semiautomatic seam welding machine 50 was 0.8 were employed as Examples 3 to 6 (comparative example 3)-2. In addition, packages for containing electronic components seam-welded under such a condition that the output ratio of the semiautomatic seam welding machine 50 was 0.6 were employed as Examples 3 to 6 (comparative example 3)-3. In all of Examples 3 to 6 and comparative example 3, the welding speed ratio was set to 1.0.

(Leak Test)

As the leak tests, an He leak test for detecting minute leaks and a bubble leak test for detecting large leaks were conducted in accordance with JIS C60068-2-17. In the He leak test, an He introducer was brought into a decompressed state by degassing, in a state arranging the packages for containing electronic components according to Examples 1 and 3 to 6 (comparative example 3)-1, Examples 1 and 3 to 6 (comparative example 3)-2, Examples 1 and 3 to 6 (comparative example 3)-3 and Example 1-4 in the He introducer. Thereafter He was introduced into the He introducer to reach 0.4 MPa (pressurized state), and the He introducer was thereafter held in the pressurized state for 1 hour. In a case where no hermetic sealing is performed in any package for an electronic component at this time, He is introduced into the package for an electronic component. Thereafter the presence or absence of leaks of He was measured by arranging the packages for containing electronic components taken out of the introducer in a leak tester. In a case where He is introduced into any package for containing an electronic component, He is detected in the leak tester. Consequently, it is detected that minute holes are present in the package for containing an electronic component and no hermetic sealing is performed.

In the bubble leak test, whether or not air bubbles (bubbles) came from the packages for containing electronic components was observed by introducing the packages for containing electronic components according to Examples 1 and 3 to 6 (comparative example 3)-1, Examples 1 and 3 to 6 (comparative example 3)-2, Examples 1 and 3 to 6 (comparative example 3)-3 and Example 1-4 into a fluorine-based inactive liquid of 125° C. for 30 seconds. In this bubble leak test, large holes hard to detect in the He leak test are detected.

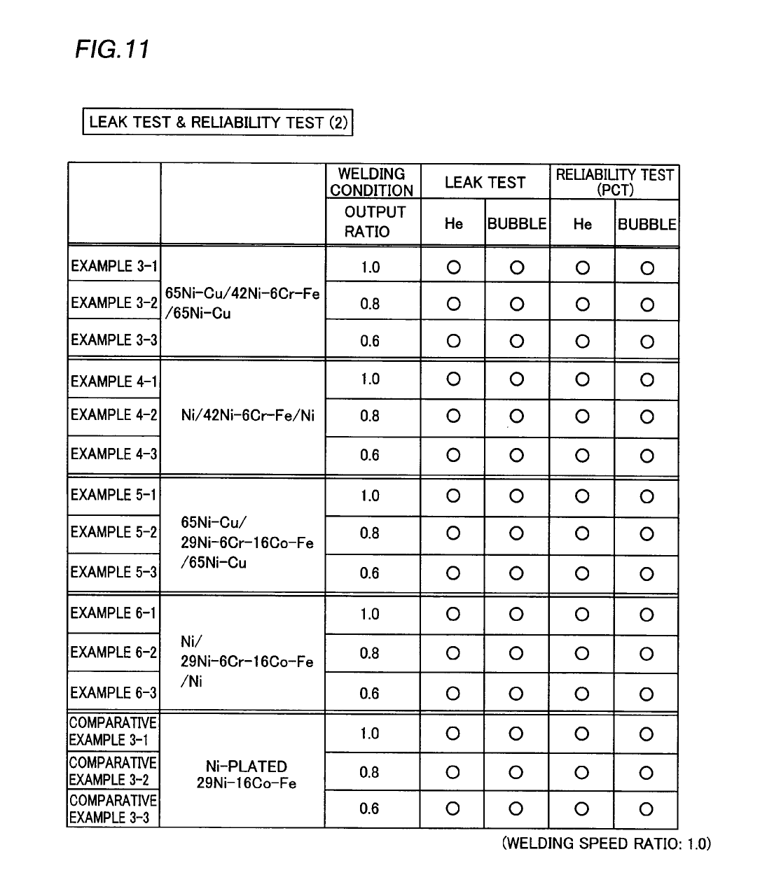

Referring to FIGS. 10 and 11, ◯ marks (circular marks) were put on cases where no leaks were confirmable in all packages for containing electronic components as evaluation of the leak test. In a case where leaks were confirmed in packages for containing electronic components, the ratio of packages for containing electronic components (acceptable products) in which no leaks were confirmable among the packages for containing electronic components subjected to the leak test was recorded.

As shown in FIGS. 10 and 11, no leaks of He were detectable in the He leak test except for Example 1-4 as results of the leak test. In the bubble leak test, further, no bubbles were observable in all of Examples 1 and 3 to 6 and comparative example 3. Thus, it has been confirmable that hermetic sealing was completely performed in the packages 100 for containing electronic components according to Examples 1 and 3 to 6-1, Examples 1 and 3 to 6-2 and Examples 1 and 3 to 6-3.

In Example 1-4, on the other hand, leaks of He were detected in 28% (=100%−72%) of packages 100 for containing electronic components among the packages 100 for containing electronic components subjected to the leak test. Thus, it has been proved that packages for containing electronic components in which minute bubbles are present and hermetic sealing is not completely performed are present in Example 1-4. This is conceivably because the output was smaller than in Examples 1-1 and 1-2 and the welding speed was faster than in Examples 1-1 and 1-3 and hence not sufficiently molten portions easily occurred in the bonded regions of the surface layers 11 in Example 1-4. Thus, it is conceivably appropriate to set the output ratio of the semiautomatic seam welding machine 50 to about 0.6 and to set the welding speed ratio to at least 1.6 and not more than 2.0 or to set the output ratio to about 0.6 and to set the welding speed ratio to about 1.6, in order to completely perform hermetic sealing in the package 100 for containing an electronic component while bringing melting of the surface layer 11 into a homogeneous state neither too much nor too little.

In Examples 3 to 6 in which the contents of Ni in the surface layers 11 are at least 65%, it has been confirmable that no leaks occur in the case where the welding speed ratio is 1.0 also when the output ratio is reduced. Thus, it has been confirmable as possible to completely perform hermetic sealing in the package 100 for containing an electronic component while bringing melting of the surface layer 11 into a homogeneous state neither too much nor too little by setting the output ratio to at least 0.6 and setting the welding speed ratio to about 1.0 also in a case where the melting point of the surface layer is high due to the fact that the content of Ni is large.

(Reliability Test)

In the reliability tests, the packages for containing electronic components according to Examples 1 and 3 to 6 (comparative example 3)-1, Examples 1 and 3 to 6 (comparative example 3)-2, Examples 1 and 3 to 6 (comparative example 3)-3 and Example 1-4 of the acceptable products in which no leaks of He were detected and no bubbles were observed in the aforementioned leak tests were employed. As the reliability tests, pressure cooker tests (PCTs) and heat cycle tests were conducted. On Examples 3 to 6-1, Examples 3 to 6 (comparative example 3)-2 and Examples 3 to 6 (comparative example 3)-3, only the PCTs were conducted.

In the PCTs, the packages for containing electronic components according to Examples 1 and 3 to 6 (comparative example 3)-1, Examples 1 and 3 to 6 (comparative example 3)-2, Examples 1 and 3 to 6-3 and Example 1-4 were held under conditions (high temperature, high moisture and high pressure conditions) of 120° C., 100% RH and 0.2 MPa for 96 hours. Thereafter tests similar to the aforementioned leak tests were conducted.

In the heat cycle tests, 1000 cycles were conducted while setting a cycle of holding the packages for containing electronic components according to Examples 1-1 to 1-4 and comparative example 3-1 at −45° C. for 30 minutes and thereafter holding the same at 85° C. for 30 minutes as one cycle. Thereafter tests similar to the aforementioned leak tests were conducted.

As shown in FIGS. 10 and 11, no leaks of He were detected and no bubbles were observed in all packages for containing electronic components according to Examples 1 and 3 to 6 (comparative example 3)-1, Examples 1 and 3 to 6 (comparative example 3)-2, Examples 1 and 3 to 6 (comparative example 3)-3 and Example 1-4 of the acceptable products in the leak tests after the PCTs as results of the reliability tests. Also in the leak tests after the heat cycle tests, no leaks of He were detected and no bubbles were observed in all packages for containing electronic components according to Examples 1-1 to 1-4 and comparative example 3-1 of the acceptable products. Thus, the packages 100 for containing electronic components according to Examples 1 and 3 to 6 of the acceptable products are conceivably sufficiently high in reliability in relation to hermetic properties.

(Corrosion Resistance Test of Ni—Cu Alloy)

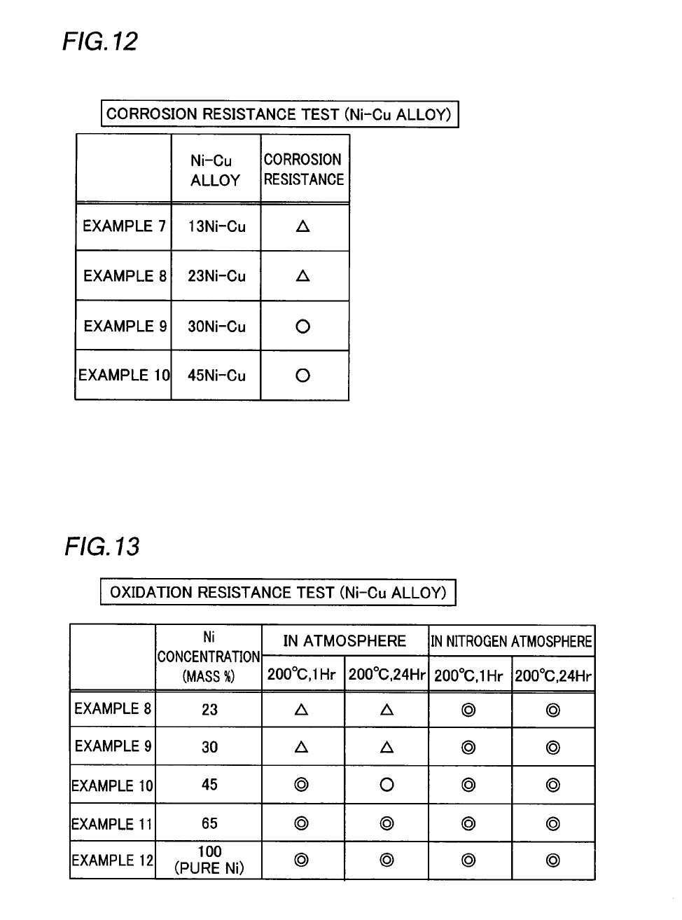

In order to confirm corrosion resistance of the Ni—Cu alloys constituting the surface materials of the cover materials for hermetic sealing, the corrosion resistance test of the Ni—Cu alloys was conducted. In the corrosion resistance test of the Ni—Cu alloys described below, Ni—Cu alloys in which the contents of Ni and Cu were varied were employed, as shown in FIG. 12.

More specifically, a 13Ni—Cu alloy containing 13 mass % of Ni and 87 mass % of Cu was employed as Example 7. Further, a 23Ni—Cu alloy containing 23 mass % of Ni and 77 mass % of Cu was employed as Example 8. In addition, a 30Ni—Cu alloy containing 30 mass % of Ni and 70 mass % of Cu was employed as Example 9. Further, a 45Ni—Cu alloy containing 45 mass % of Ni and 55 mass % of Cu was employed as Example 10.

Plate materials of 10 mm by 10 mm by 500 μm (thickness) were employed as the Ni—Cu alloy materials according to Examples 7 to 10.

Then, the corrosion resistance test was conducted with respect to the Ni—Cu alloy materials according to Examples 7 to 10. More specifically, a salt spray test was conducted in accordance with JIS C60068-2-11, similarly to the aforementioned corrosion test of the cover materials for hermetic sealing. Then, the extents of corrosion in the Ni—Cu alloy materials were observed. Referring to FIG. 12, ◯ marks (circular marks) were put on cases where corrosion was hardly confirmable in the Ni—Cu alloys as evaluation of the corrosion resistance. Further, Δ marks (triangular marks) were put on cases where slight corrosion was confirmed in the Ni—Cu alloys. In addition, x marks (x marks) were put on cases where remarkable corrosion was confirmed in the Ni—Cu alloys.

As shown in FIG. 12, slight corrosion was confirmed in the Ni—Cu alloys in Examples 7 and 8 in which the contents of Ni are not more than 23 mass %. In Examples 9 and 10 in which the contents of Ni are at least 30 mass %, on the other hand, corrosion was hardly confirmable in the Ni—Cu alloys. Thus, it has been proved as preferable to employ an Ni—Cu alloy containing at least 30 mass % of Ni in order to improve the corrosion resistance of the cover material for hermetic sealing. The melting point of an Ni—Cu alloy increases as the content of Ni enlarges, and hence an Ni—Cu alloy whose Ni content is at least 30 mass % and close to 30 mass % is preferable from the point that it is possible to lower the melting point while having sufficient corrosion resistance.

(Oxidation Resistance Test of Ni—Cu Alloy)

Further, the oxidation resistance test of Ni—Cu alloys was conducted in order to confirm oxidation resistance of the Ni—Cu alloys constituting surface materials of cover materials for hermetic sealing. In the oxidation resistance test of the Ni—Cu alloys described below, plate materials of Ni—Cu alloys in which the contents of Ni and Cu were varied or a plate material of Ni was employed, as shown in FIG. 13.

More specifically, a plate material of a 65Ni—Cu alloy containing 65 mass % of Ni and 35 mass % of Cu was employed as Example 11, in addition to the plate material according to Example 8 (23Ni—Cu alloy), the plate material according to Example 9 (30Ni—Cu alloy) and the plate material according to Example 10 (45Ni—Cu alloy) employed in the aforementioned corrosion resistance test. Further, a plate material of pure Ni containing no Cu was employed as Example 12.

Then, the oxidation resistance test was conducted with respect to the plate materials of the Ni—Cu alloys (pure Ni) according to Examples 8 to 12. More specifically, the extents of discoloration on the plate material surfaces resulting from oxidation were observed by performing heating in the atmosphere at 200° C. for a prescribed time (one hour or 24 hours). Further, oxygen concentrations in the surfaces after the heat treatment were measured by EDX. As a comparative experiment, a test similar to the aforementioned one in the atmosphere was conducted also in a nitrogen atmosphere.

Referring to FIG. 13, ⊚ marks (double circular marks) were put on cases where the surfaces of a metallic color (the so-called silver) remained substantially unchanged. Further, ◯ marks (circular marks) were put on cases where no remarkable discoloration occurred although the surfaces of the metallic color were slightly colored. In addition, Δ marks (triangular marks) were put on cases where the surfaces of the metallic color were remarkably discolored to ocher or black.

As shown in FIG. 13, no discoloration was confirmable at all in the nitrogen atmosphere in any one of Examples 8 to 12. In other words, it has been confirmable that no discoloration occurs in the nitrogen atmosphere in which no oxygen is present. In the atmosphere in which oxygen is present, on the other hand, remarkable discoloration was confirmed in the Ni—Cu alloys in Examples 8 and 9 in which the Ni contents are not more than 30 mass %, in both of the case of heating the same at 200° C. for one hour and the case of heating the same at 200° C. for 24 hours. In Examples 11 and 12 in which the Ni contents are at least 65 mass %, on the other hand, discoloration resulting from oxidization was hardly confirmable in the Ni—Cu alloys in both of the case of heating the same at 200° C. for one hour and the case of heating the same at 200° C. for 24 hours. Thus, it has been proved as preferable to employ an Ni—Cu alloy containing at least 65 mass % of Ni in order to remarkably improve the oxidation resistance of the cover material for hermetic sealing.

In the atmosphere, discoloration resulting from oxidation was hardly confirmable in Example 10 in which the Ni content is 45 mass % in the case of heating the same at 200° C. for one hour, while slight discoloration was confirmed in the Ni—Cu alloy in the case of heating the same at 200° C. for 24 hours. Thus, it has been proved as preferable to employ an Ni—Cu alloy containing at least 45 mass % of Ni in order to improve the oxidation resistance of the cover material for hermetic sealing to a certain degree.

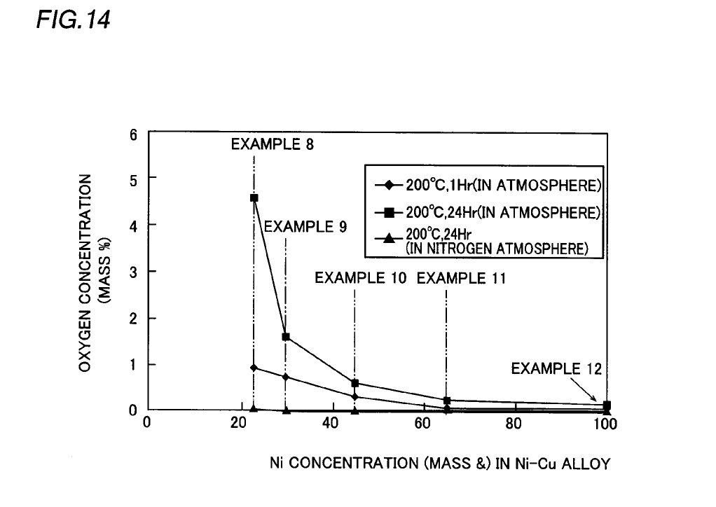

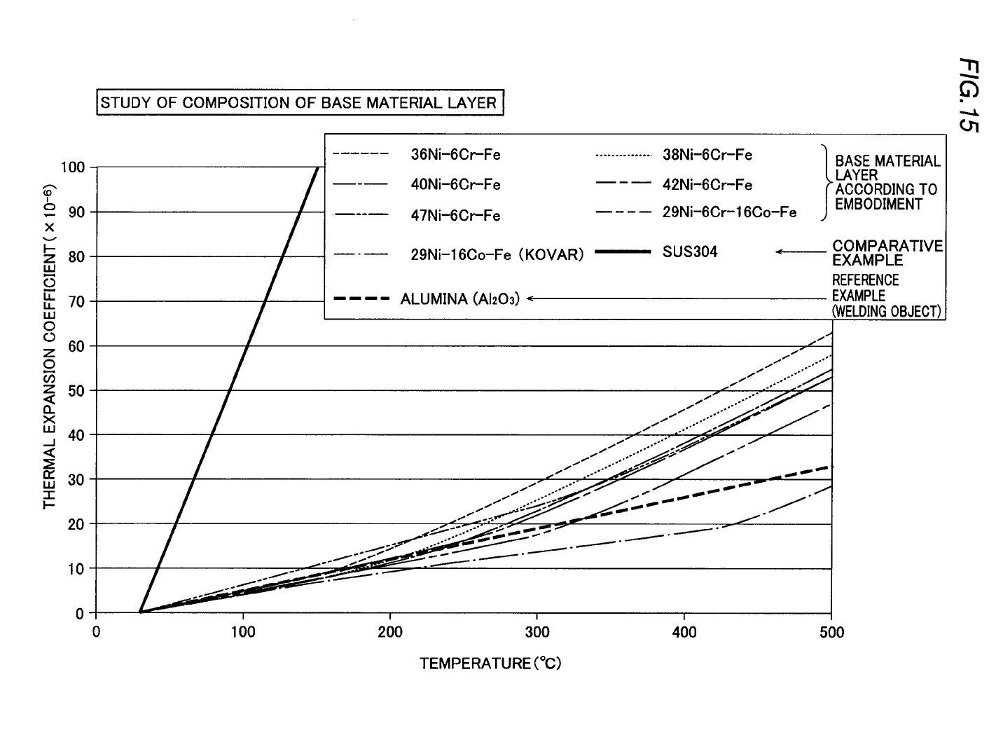

Also from results of the EDX shown in FIG. 14, it has been confirmable that the oxygen concentration in the plate material surface after the heat treatment reduces by enlarging the content of Ni. From the graph shown in FIG. 14, the oxygen concentration conceivably becomes not more than about 0.3 mass % when it is the Ni—Cu alloy containing at least 60 mass %, also in a case of heating the Ni—Cu alloy at 200° C. for 24 hours. Consequently, it is conceivable that decoloration hardly occurs and it is possible to sufficiently improve oxidation resistance when it is an Ni—Cu alloy containing at least 60 mass % of Ni.

From these, an Ni—Cu alloy containing about 30 mass % of Ni has been preferable in the point that the same has sufficient corrosion resistance and it is possible to lower the melting point, while the same is conceivably not much suitable in a case where visual attractiveness is necessary since the same has low oxidation resistance and is easily discolored. In a case where visual attractiveness is particularly important although the melting point increases, it is conceivably more preferable to employ an Ni—Cu alloy containing about 60 mass % of Ni having remarkable resistance against oxidation and substantially not discolored. In a case where visual attractiveness such as discoloration is necessary to a certain degree, it is conceivably more preferable to employ an Ni—Cu alloy containing Ni in which the content of Ni is about 45 mass %, since discoloration can also be prevented to a certain degree while lowering the melting point.

(Study of Composition of Base Material Layer Based on Thermal Expansion Property)

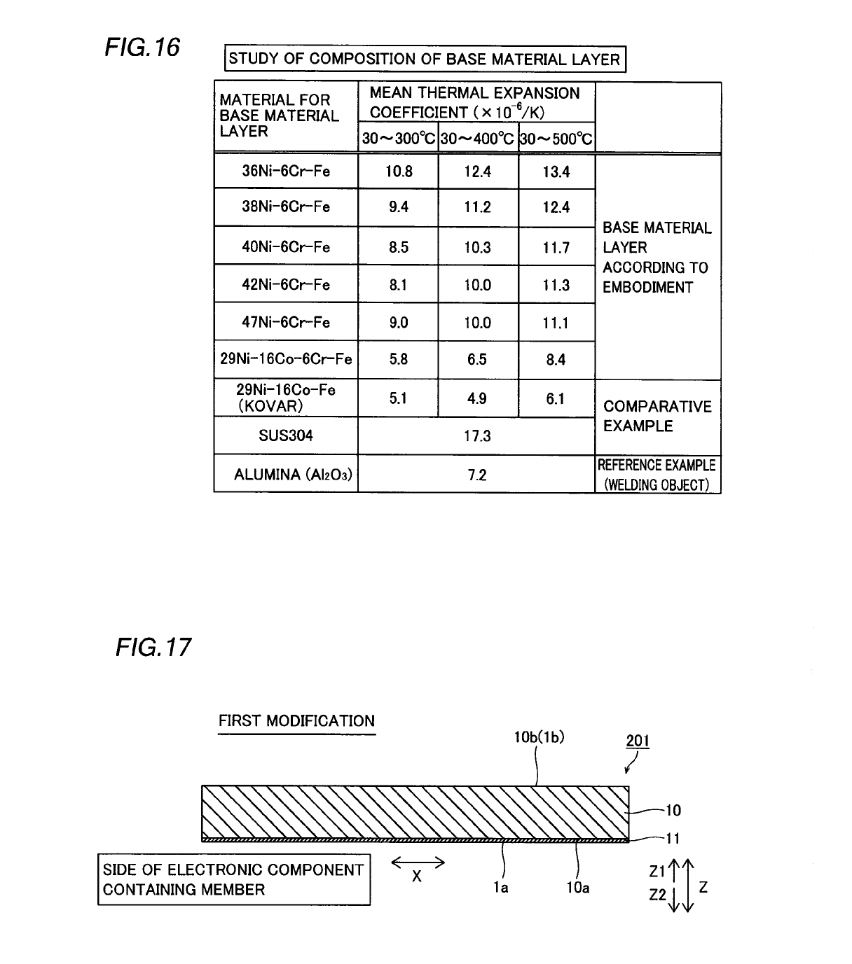

Finally, the compositions of alloys suitable for the base material layer according to the present invention were studied on the basis of the thermal expansion coefficients of the Ni—Cr—Fe alloys and the Ni—Cr—Co—Fe alloy constituting the base material layers 10 employed for the cover materials 1 for hermetic sealing. The Ni—Cr—Fe alloys and the Ni—Cr—Co—Fe alloy having thermal expansion coefficients close to the thermal expansion coefficient of alumina (Al₂O₃) constituting the welding object (the base 31) in the sealing are conceivably suitable as the base material layer. While FIG. 15 graphically shows changes of thermal expansion coefficients with respect to temperature changes, FIG. 16 shows mean thermal expansion coefficients in prescribed temperature ranges (from 30° C. to 300° C., from 30° C. to 400° C. and from 30° C. to 500° C.)

From the graph shown in FIG. 15, the thermal expansion coefficients were small at any temperature in all of the Ni—Cr—Fe alloys and the Ni—Cr—Co—Fe alloy, which had thermal expansion coefficients close to the thermal expansion coefficient of alumina (Al₂O₃), as compared with the thermal expansion coefficient of SUS304 which is comparative example. From the table shown in FIG. 16, the mean thermal expansion coefficients (at least 5.8×10⁻⁶/K and not more than 13.4×10⁻⁶/K) were small in any temperature range in all of the Ni—Cr—Fe alloys and the Ni—Cr—Co—Fe alloy, which had mean thermal expansion coefficients close to the mean thermal expansion coefficient (7.2×10⁻⁶/K) of alumina (Al₂O₃), as compared with the mean thermal expansion coefficient (17.3×10⁻⁶/K) of SUS304 which is comparative example. In other words, the Ni—Cr—Fe alloys and the Ni—Cr—Co—Fe alloy are conceivably more suitable for the base material layer than SUS304.

In the Ni—Cr—Fe alloys, the thermal expansion coefficients reduced as a whole and approximated the thermal expansion coefficient of alumina, as the contents of Ni were enlarged. When the contents of Ni were at least 40 mass %, on the other hand, changes of the thermal expansion coefficients were not much confirmable.

As to the thermal expansion coefficient of the Ni—Cr—Co—Fe alloy (29Ni-6Cr-16Co—Fe alloy), the thermal expansion coefficient became larger than that of the 29Ni-16Co—Fe alloy (the so-called Kovar) containing no Cr at any temperature, while the same became smaller than the thermal expansion coefficients of the Ni—Cr—Fe alloys, and most approximated the thermal expansion coefficient of alumina.

While the mean thermal expansion coefficient of alumina became 7.2×10⁻⁶/K in the temperature range from 30° C. to 400° C. in this experiment, the mean thermal expansion coefficient of alumina is generally included in the range of at least 6.4×10⁻⁶/K and not more than 8.1×10⁻⁶/K in the temperature range from 30° C. to 400° C. Therefore, an alloy close to this range of the mean thermal expansion coefficient of alumina is conceivably suitable for the base material layer. In other words, the Ni—Cr—Fe alloys in which the Ni contents are at least 40 mass % or the Ni—Cr—Co—Fe alloy (29Ni-6Cr-16Co—Fe alloy) is conceivably suitable for the base material layer.

The embodiment and Examples disclosed this time must be considered as illustrative in all points and not restrictive. The range of the present invention is shown not by the above description of the embodiment and Examples but by the scope of claims for patent, and all modifications within the meaning and range equivalent to the scope of claims for patent are included.

For example, while the above embodiment has shown such an example that the cover material 1 for hermetic sealing consists of the three-layer clad material constituted of the base material layer 10 and the surface layers 11 and 12 pressure-bonded to the lower surface 10a and the upper surface 10b of the base material layer 10 respectively, the present invention is not restricted to this. According to the present invention, a cover material 201 for hermetic sealing may be so configured as to consist of a two-layer clad material constituted of a base material layer 10 and a surface layer 11 pressure-bonded to a lower surface 10a (the surface on the side (Z2 side) of an electronic component containing member) of the base material layer 10, as in a first modification of this embodiment shown in FIG. 17.

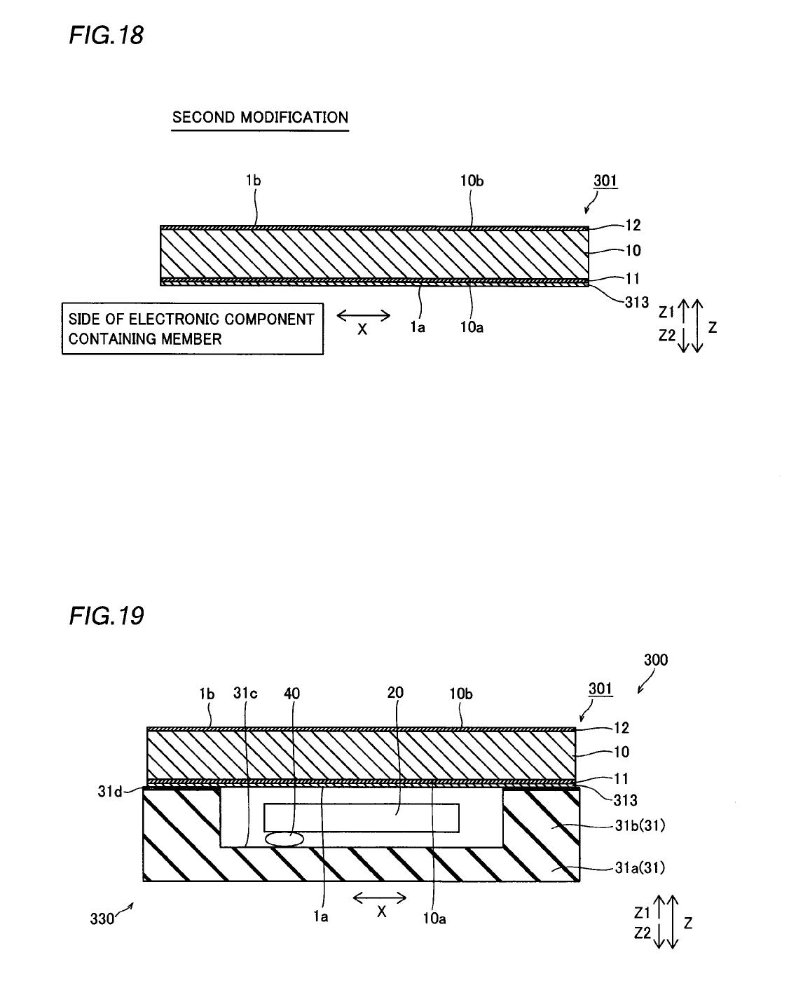

Further, a cover material 301 for hermetic sealing may be so configured as to consist of a four-layer clad material constituted of not only a base material layer 10 and surface layers 11 and 12 pressure-bonded to a lower surface 10a and an upper surface 10b of the base material layer 10 respectively but also a silver solder layer 313 pressure-bonded to the lower surface (on the side of a battery component containing member) of the surface layer 11, as in a second modification of this embodiment shown in FIGS. 18 and 19. A silver solder material consisting of 72 mass % of Ag and Cu is preferably employed as the silver solder layer 313.

In a package 300 for containing an electronic component according to the second modification of this embodiment shown in FIG. 19, an electronic component containing member 330 consists of only a base 31, and is provided with no sealing ring, dissimilarly to the aforementioned embodiment. The silver solder layer 313 and the base 31 are welded to each other by seam welding or electron beam welding in a state where the silver solder layer 313 of the cover material 301 for hermetic sealing and a metallized layer 31d of the base 31 are in contact with each other. At this time, the melting point of the silver solder layer 313 consisting of the silver solder material consisting of 72 mass % of Ag and Cu is about 780° C., and the melting point is lower than that of an Ni—Cu alloy or Ni, whereby it is possible to reduce thermal stress generated at the time of sealing. While weld marks are formed on outer edge portions of the cove material 301 for hermetic sealing and the base 31 in the case of performing the seam welding, weld marks are formed on an inner side (the side where a crystal unit 20 is contained) beyond the outer edge portions of the cove material 301 for hermetic sealing and the base 31 in the case of performing the electron beam welding.

In the aforementioned second modification, the cover material 301 for hermetic sealing and a sealing ring can be sealed (brazed/bonded) to each other without providing a silver solder portion on the sealing ring bonded to the cover material 301 for hermetic sealing, whereby the number of components can be reduced when preparing the package 300 for containing an electronic component.

While the aforementioned embodiment has shown such an example that the content of Ni in the Ni—Cr—Fe alloy or the Ni—Cr—Co—Fe alloy constituting the base material layer 10 is at least about 36 mass % and not more than about 48 mass %, the present invention is not restricted to this. According to the present invention, the base material layer may simply be made of an Ni—Cr—Fe alloy, and the content of Ni may not be at least about 36 mass % and not more than about 48 mass %. At this time, the thermal expansion coefficient of the Ni—Cr—Fe alloy constituting the base material layer preferably has a value approximate to the thermal expansion coefficients of the base and the sealing ring, in order to prevent breakage of the package for containing an electronic component resulting from thermal stress.

While the aforementioned embodiment has shown such an example that the surface layers 11 and 12 are made of the Ni—Cu alloy or Ni, the present invention is not restricted to this. According to the present invention, the surface layers may simply be made of an Ni alloy, and are not restricted to the Ni—Cu alloy or Ni. In this case, the melting point of the Ni alloy is preferably lower than that of Ni, and an Ni—Ag alloy, an Ni—Al alloy, an Ni—Au alloy, an Ni—Bi alloy, an Ni—Co alloy, an Ni—Cr alloy, an Ni—Fe alloy, an Ni—Ti alloy, an Ni—Si alloy, an Ni—Sn alloy, an Ni—Mn alloy, an Ni—Mg alloy, an Ni—P alloy, an Ni—V alloy, an Ni—Zn alloy or the like is preferable, for example.

While the aforementioned embodiment has shown such an example that the surface layers 11 and 12 are made of the same metallic material, the present invention is not restricted to this. According to the present invention, the surface layers 11 and 12 may be made of different metallic materials. At this time, the surface layer 12 on the side opposite to the electronic component containing member 30 may be made of an Ni—Cu alloy containing Ni and Cu, or a metallic material having corrosion resistance other than Ni.

While the aforementioned embodiment has shown such an example that the cover material 1 for hermetic sealing has the thickness t1 of about 80 μm, the present invention is not restricted to this. According to the present invention, the thickness of the cover material for hermetic sealing may be a thickness other than about 80 μm. The thickness of the cover material for hermetic sealing is preferably at least about 70 μm and not more than about 150 μm. At this time, the thickness of the surface layer at least arranged on the surface on the side of the electronic component containing member is preferably at least 1 μm and not more than 10 μm, regardless of the thickness of the cover material for hermetic sealing.

While the aforementioned embodiment has shown such an example that the upper surface 1b of the cover material 1 for hermetic sealing is in the form of a planar surface, the present invention is not restricted to this. According to the present invention, the peripheral edge portion of the upper surface of the cover material for hermetic sealing may be so inclined that the thickness of the cover material for hermetic sealing reduces toward the outer edge of the cover material for hermetic sealing, thereby coinciding with the inclination of the roller electrodes of tapered shapes. Thus, it is possible to enlarge contact areas of the cover material for hermetic sealing and the pair of roller electrodes.

While the aforementioned embodiment has shown the example of bonding the cover material 1 for hermetic sealing and the electronic component containing member 30 to each other by seam welding which is a sort of resistance welding, the present invention is not restricted to this. For example, the cover material for hermetic sealing and the electronic component containing member may be bonded to each other by resistance spot welding which is a sort of resistance welding. Further, the cover material for hermetic sealing and the electronic component containing member may be bonded to each other by employing a bonding method other than the resistance welding. For example, the cover material for hermetic sealing and the electronic component containing member may be bonded to each other by electron beam welding employing electron beams. At this time, it is preferable since the surface layers can be easily molten with the electron beams, by preparing the surface layers from an Ni—Cu alloy whose melting point is low.

While the aforementioned embodiment has shown the example of containing the crystal unit 20 in the electronic component containing member 30, the present invention is not restricted to this. For example, an SAW filter (surface acoustic wave filter) or the like may be contained in the electronic component containing member.

### DESCRIPTION OF REFERENCE SIGNS

1, 201, 301 cover material for hermetic sealing
10 base material layer
10a lower surface (one surface)
10b upper surface (another surface)
11 surface layer (first surface layer)
12 surface layer (second surface layer)
20 crystal unit (electronic component)
30, 330 electronic component containing member
100, 300 package for containing electronic component
313 silver solder layer

1. A cover material for hermetic sealing employed for a package for containing an electronic component including an electronic component containing member for containing an electronic component, constituted of a clad material comprising:
a base material layer made of an Ni—Cr—Fe alloy containing Ni, Cr and Fe or an Ni—Cr—Co—Fe alloy containing Ni, Cr, Co and Fe; and
a surface layer at least bonded to one surface of the base material layer on a side of the electronic component containing member and made of Ni or an Ni alloy.

2. The cover material for hermetic sealing according to claim 1, wherein
the base material layer is made of an Ni—Cr—Fe alloy or an Ni—Cr—Co—Fe alloy containing at least 1 mass % and not more than 10 mass % of Cr.

3. The cover material for hermetic sealing according to claim 2, wherein
the base material layer is made of an Ni—Cr—Fe alloy or an Ni—Cr—Co—Fe alloy containing at least 6 mass % and not more than 10 mass % of Cr.

4. The cover material for hermetic sealing according to claim 1, wherein
the base material layer is made of an Ni—Cr—Co—Fe alloy containing at least 6 mass % and not more than 18 mass % of Co.

5. The cover material for hermetic sealing according to claim 1, wherein
the surface layer is made of an Ni—Cu alloy containing Ni and Cu.

6. The cover material for hermetic sealing according to claim 5, wherein
the surface layer is made of an Ni—Cu alloy containing at least 30 mass % of Ni.

7. The cover material for hermetic sealing according to claim 6, wherein
the surface layer is made of an Ni—Cu alloy containing at least 60 mass % of Ni.

8. The cover material for hermetic sealing according to claim 1, wherein
the surface layer has a thickness of at least 1 μm and not more than 10 μm.

9. The cover material for hermetic sealing according to claim 8, wherein
the surface layer has a thickness of at least 2 μm and not more than 6 μm.

10. The cover material for hermetic sealing according to claim 1, wherein
the surface layer includes a first surface layer bonded onto the surface of the base material layer on the side of the electronic component containing member and a second surface layer bonded onto another surface of the base material layer on a side opposite to the electronic component containing member.

11. The cover material for hermetic sealing according to claim 10, wherein
the second surface layer is made of the same metallic material as the first surface layer.

12. The cover material for hermetic sealing according to claim 10, wherein
the clad material includes a silver solder layer at least bonded onto a surface of the first surface layer on the side of the electronic component containing member.

13. The cover material for hermetic sealing according to claim 11, wherein
the base material layer is made of an Ni—Cr—Fe alloy containing at least 36 mass % and not more than 48 mass % of Ni, at least 1 mass % and not more than 10 mass % of Cr and Fe, and
the first surface layer and the second surface layer are both made of an Ni—Cu alloy containing at least 30 mass % of Ni or Ni.

14. The cover material for hermetic sealing according to claim 13, wherein
the base material layer is made of an Ni—Cr—Fe alloy containing at least 36 mass % and not more than 48 mass % of Ni, at least 6 mass % and not more than 10 mass % of Cr and Fe, and
the first surface layer and the second surface layer are both made of an Ni—Cu alloy containing at least 30 mass % of Ni.

15. The cover material for hermetic sealing according to claim 4, wherein
the clad material is made of an Ni—Cr—Co—Fe alloy containing at least 1 mass % and not more than 10 mass % of Cr, at least 6 mass % and not more than 18 mass % of Co and Fe.

16. The cover material for hermetic sealing according to claim 1, wherein
the surface layer bonded to the surface of the base material layer on the side of the electronic component containing member is configured to function as a melting bonding layer when resistance-welded with respect to the electronic component containing member.

17. A package for containing an electronic component comprising:
an electronic component containing member for containing an electronic component; and
the cover material for hermetic sealing according to claim 1 resistance-welded with respect to the package for containing an electronic component.

18. The package for containing an electronic component according to claim 17, wherein
the surface layer bonded to the surface of the base material layer on the side of the electronic component containing member functions as a melting bonding layer when resistance-welded with respect to the package for containing an electronic component.
